(19) United States
(12) Patent Application Publication
(10) Pub. No.: US 2020/0123708 A1
(43) Pub. Date: Apr. 23, 2020

(54) REINFORCED PAPER, METHOD OF MAKING A REINFORCED PAPER, AND ARTICLE COMPRISING A REINFORCED PAPER

(71) Applicant: SABIC GLOBAL TECHNOLOGIES B.V., Bergen op Zoom (NL)

(72) Inventors: Eddie Kebin Geng, Houston, TX (US); Peter James Zuber, Houston, TX (US); Viswanathan Kalyanaraman, Mt. Vernon, IN (US); Scott Michael Fisher, Selkirk, NY (US); Nancy Jestel, Selkirk, NY (US); Eylem Tarkin-Tas, Selkirk, NY (US)

(21) Appl. No.: 16/619,550

(22) PCT Filed: Jun. 11, 2018
(86) PCT No.: PCT/US2018/036870

§ 371 Date: Dec. 5, 2019

Related U.S. Application Data
(60) Provisional application No. 62/527,149, filed on Jun. 30, 2017.

(51) Int. Cl. D21H 17/53; B32B 27/12; B32B 3/12; B32B 5/02; B32B 5/26; D21H 13/26; D21H 13/50; D21H 17/54; D21H 25/06

(52) U.S. Cl. CPC D21H 17/53; B32B 2262/108; B32B 3/12; B32B 5/022; B32B 5/26; D21H 13/26; D21H 13/50; D21H 17/54; D21H 25/06; B32B 2260/021; B32B 2260/046; B32B 2262/0269; B32B 2262/0276; B32B 2262/101; B32B 2262/106; B32B 2262/105; B32B 27/12

(57) ABSTRACT

A reinforced paper includes a nonwoven fibrous mat impregnated with a polyetherimide composition. The nonwoven fibrous mat includes a reinforcing fiber, a high strength toughening fiber, or a combination thereof. The polyetherimide composition includes a polyetherimide having repeating units as defined herein. A method of making a reinforced paper is also disclosed. The method includes contacting at least a portion of a nonwoven fibrous mat with a composition to form a pre-preg, and heating under conditions effective to provide the reinforced paper. Articles including the reinforced paper are also described.

### BACKGROUND

Core structures for sandwich panels from aramid fiber papers or nonwovens made by a wet-laid, a dry-laid, or a spun-laid process, usually having a honeycomb or other light-weight, high-strength folded cellular structure, are used in a variety of applications. For example, panels having folded cellular core structures can be used in the aerospace industry, packaging applications, transportation interior components, light-weight construction materials, and athletic products. Current materials are typically made from a specially developed paper product that has high strength and temperature capabilities, but such materials also face some technical limitations including low mechanical strength, high moisture uptake, poor flame performance, and poor long term stability. Materials used to strengthen the paper, including epoxies, phenolics or other thermosetting polymer technologies also tend to increase the heat release rate and smoke.

An example of a light-weight, folded-cell structure is a honeycomb structure, which is generally made from thin, high tensile strength paper by printing adhesive lines on the contact surface of the paper, then alternating the spacing of up to 2000 or more sheets and curing the adhesive under pressure and heat. The resulting paper stack can then be expanded, by pulling the top and bottom sheet of an individual block away from each other as in the opening of an accordion. This expands the paper stack into a block of a honeycomb pattern in which the glue lines define the attachment points between the sheets in the stack, and the spacing between adjacent pairs of glue lines defines the width of individual walls that make the honeycomb pattern. Air can be blown through the honeycomb to assist in expansion. The honeycomb can be heat set at high temperature and coated or impregnated with a varnish or resin, which, after curing, stabilizes the structure, adding to the strength and stiffness. The honeycomb can then be sliced into the desired thickness.

Printing the lines, heat setting, dipping and curing the adhesive, and dipping in varnish or resin, up to 32 times, followed each time by curing can add considerably to cost and time, and require expensive printing equipment and powerful hydraulics to open the honeycomb. Additionally, current papers made from aramid fibers and fibrids are inherently hygroscopic, losing their strength at high humidity. Moisture can also collect in the paper due to changes in pressure and relative humidity, leading to a significant impact on the weight, which is a critical factor especially in aerospace and transportation applications. Furthermore, as mentioned above, the papers are generally treated with an epoxy or phenolic resin to strengthen and stiffen the paper, adding process steps and time to the production of the paper. The epoxy or phenolic coatings can undesirably add fuel, smoke, and toxic components to the structure, and can thus require additional additives to provide the desired burning performance

There remains a continuing need in the art for reinforced papers (for example, reinforced honeycomb or other folded cell papers) that can overcome the above-described technical limitations. It would be particularly desirable to provide a reinforced paper that has at least one of improved (reduced) moisture uptake, flame performance, long term stability, or mechanical strength. Such reinforced papers would be useful for a variety of applications, in particular, aerospace and transportation applications. It would further be desirable if the method of making such reinforced papers was more efficient, environmentally friendly, and did not involve multiple coatings with organic solvent-containing solutions.

### BRIEF SUMMARY

One embodiment is a reinforced paper comprising a nonwoven fibrous mat comprising a reinforcing fiber, a high strength toughening fiber, or a combination thereof; wherein the nonwoven fibrous mat is impregnated with a polyetherimide composition; wherein the polyetherimide composition comprises a polyetherimide comprising repeating units of the formula

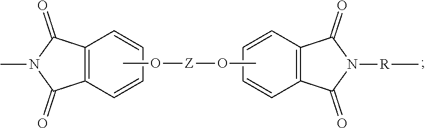

wherein each occurrence of R is independently a substituted or unsubstituted C₆₋₂₀ aromatic hydrocarbon group, a substituted or unsubstituted straight or branched chain C₄₋₂₀ alkylene group, a substituted or unsubstituted C₃₋₈ cycloalkylene group, or a combination thereof; and each occurrence of Z is independently a group of the formula

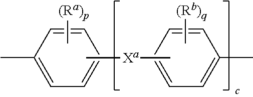

wherein R^{a} and R^{b} are each independently a halogen atom or a monovalent C₁₋₆ alkyl group; p and q are each independently integers of 0 to 4; c is 0 to 4; and X^{a} is a single bond, —O—,—S—, —S(O)—, —SO₂—, —C(O)—, or a C₁₋₁₈ organic bridging group.

Another embodiment is a method of making a reinforced paper, the method comprising contacting at least a portion of a nonwoven fibrous mat comprising a reinforcing fiber, a high strength toughening fiber, or combination thereof, with a composition comprising a solvent and a polyetherimide, a polyamic acid salt, or a combination thereof to form a pre-preg; and heating the pre-preg under conditions effective to provide the reinforced paper comprising the nonwoven fibrous mat impregnated with a polyetherimide composition.

Another embodiment is an article comprising the reinforced paper.

These and other embodiments are described in detail below.

### BRIEF DESCRIPTION OF THE DRAWINGS

The following Figures are exemplary embodiments.

FIG. 1 shows the molecular weight of polyetherimide polymers versus reaction time under different reaction conditions.

FIG. 2 shows the weight percentage of a polyetherimide added to a paper after impregnating various papers with compositions having varying polymer concentrations.

### DETAILED DESCRIPTION

The present inventors have determined that a reinforced paper impregnated with a polyetherimide can be prepared, where the reinforced paper described herein exhibits improved mechanical properties and reduced water absorption, and thus is suitable for use in aerospace applications (e.g., as aircraft panels). Furthermore, polyetherimides are inherently flame retardant materials that are generally difficult to ignite and generate low amounts of smoke. The reinforced papers disclosed herein can be particularly useful in applications where flame and smoke properties are of concern. Advantageously, the reinforced papers can be prepared from a composition that includes a polyetherimide prepolymer salt dissolved in water or an alcoholic solvent. Additionally, the compositions used to prepare the reinforced papers are of low viscosity, providing enhanced wetting and impregnation of the paper with the composition.

Accordingly, an aspect of the present disclosure is a reinforced paper. The reinforced paper comprises a nonwoven fibrous mat comprising a reinforcing fiber, a high strength toughening fiber, or a combination comprising at least one of the foregoing. The nonwoven fibrous mat can further include a thermoplastic fiber, a binder material, or both, as further described below.

The term “fibers” as used herein includes a wide variety of structures having a single filament with an aspect ratio (length:diameter) of greater than 2. The term fibers also includes fibrets (very short (length less than 1 millimeter (mm)), fine (diameter less than 50 micrometer (μm)) fibrillated fibers that are highly branched and irregular resulting in high surface area, and fibrils, tiny threadlike elements of a fiber. “Fibrids”, as used herein, means very small, nongranular, fibrous or film-like particles with at least one of their three dimensions being of minor magnitude relative to the largest dimension, such that they are essentially two-dimensional particles, typically having a length of greater than 0 to less than 0.3 mm, and a width of greater than 0 to less than 0.3 mm and a depth of greater than 0 to less than 0.1 mm

Suitable reinforcing fibers can include organic or inorganic materials, and are high strength, high modulus, and high stiffness reinforcing materials. For example, the reinforcing fiber can generally have a tensile modulus of greater than or equal to 20 to 90 msi (million pounds per square inch). In some embodiments, the reinforcing fiber can preferably have a tensile modulus of 15 to 55 msi.

The reinforcing fiber can include, for example, carbon fiber, carbon nanotubes (e.g., multi-wall carbon nanotubes, single-wall carbon nanotubes, or a combination thereof), glass fiber, basalt fiber, silicon carbide fibers, tungsten carbide fibers, wollastonite fibers, alumina fibers, aluminium silicate fibers, silica fibers, or a combination thereof. In some embodiments, the reinforcing fiber can be a metal fiber, a metalized organic fiber, or a combination thereof. Preferably, the reinforcing fiber can comprise carbon fiber. Various types of carbon fibers are known in the art, and can be classified according to their diameter, morphology, and degree of graphitization (morphology and degree of graphitization being interrelated). Carbon fibers are can be cylindrical and can have diameters of about 3 to about 2000 nanometers, for example 5 to 10 nanometers. Particularly useful carbon fibers can be microscale in length. These characteristics are presently determined by the method used to synthesize the carbon fiber. For example, carbon fibers having diameters down to about 5 micrometers, and graphene ribbons parallel to the fiber axis (in radial, planar, or circumferential arrangements) are produced commercially by pyrolysis of organic precursors in fibrous form, including phenolics, polyacrylonitrile (PAN), or pitch. These types of fibers have a relatively lower degree of graphitization.

Nanoscale carbon fibers are also contemplated, and can include graphitic or partially graphitic carbon fibers having diameters of about 3.5 to about 500 nanometers, with diameters of about 3.5 to about 70 nanometers being preferred, and diameters of about 3.5 to about 50 nanometers being more preferred. Representative carbon fibers are the vapor grown carbon fibers described in, for example, U.S. Pat. Nos. 4,565,684 and 5,024,818 to Tibbetts et al.; U.S. Pat. No. 4,572,813 to Arakawa; U.S. Pat. No. 4,663,230 and 5,165,909 to Tennent; U.S. Pat. No. 4,816,289 to Komatsu et al.; U.S. Pat. No. 4,876,078 to Arakawa et al.; U.S. Pat. No. 5,589,152 to Tennent et al.; and U.S. Pat. No. 5,591,382 to Nahass et al. Carbon fibers are available commercially, for example, from Toho, Toray, Cytec, Zoltec, Mitsubishi, Aksa, SGL, and Ardima.

The nonwoven fibrous mat can include the reinforcing fiber in an amount of 3 to 30 weight percent, or 5 to 30 weight percent, or 5 to 25 weight percent, or 10 to 20 weight percent, or about 15 weight percent, based on the total weight of the nonwoven fibrous mat.

The nonwoven fibrous mat further comprises a high strength toughening fiber component, which can compTYrise an organic material, for example, an organic polymeric material. The high strength toughening fiber can comprise, for example, a liquid crystal polymer (e.g., Vectran), a polyamide (e.g., Nylon 6.6, 6, 11, 12, 4.6, and the like, and aramids), and the like, or a combination comprising at least one of the foregoing. The high strength toughening fiber can preferably comprise a polyamide, specifically an aromatic polyamide. Aromatic polyamide fibers, also known as aramid fibers, can be broadly categorized as para-aramid fibers or meta-aramid fibers. Illustrative examples of para-aramid fibers include poly(p-phenylene terephthalamide) fibers (produced, e.g., by E. I. Du Pont de Nemours and Company and Du Pont-Toray Co., Ltd. under the trademark KEVLAR), p-phenylene terephthalamide/p-phenylene 3,4′-diphenylene ether terephthalamide copolymer fibers (produced by Teijin Ltd. under the trade name TECHNORA), (produced by Teijin Ltd. under the trade name designation TWARON), or combinations comprising at least one of the foregoing aramids. Illustrative examples of meta-aramid fibers include poly(m-phenylene terephthalamide) fibers (produced, e.g., by E. I. Du Pont de Nemours and Company under the trademark NOMEX). Such aramid fibers can be produced by methods known to one skilled in the art. In a specific embodiment, the aramid fibers are para-type homopolymers, for example poly(p-phenylene terephthalamide) fibers.

Wholly aromatic polyester fibers include liquid crystal polyesters. Illustrative examples of such wholly aromatic polyester fibers include self-condensed polymers of p-hydroxybenzoic acid, polyesters comprising repeat units derived from terephthalic acid and hydroquinone, polyester fibers comprising repeat units derived from p-hydroxybenzoic acid and 6-hydroxy-2-naphthoic acid, or combinations thereof. A specific wholly aromatic liquid crystal polyester fiber is produced by the polycondensation of 4-hydroxybenzoic acid and 6-hydroxynaphthalene-2-carboxylic acid (commercially available from Kuraray Co., Ltd. under the trade name designation VECTRAN). Such wholly aromatic polyester fibers can be produced by any methods known to one skilled in the art.

The nonwoven fibrous mat can include the high strength toughening fiber in an amount of 5 to 55 weight percent, or 15 to 55 weight percent, or 15 to 45 weight percent, or 15 to 35 weight percent, or 20 to 30 weight percent, or about 25 percent, based on the total weight of the nonwoven fibrous mat.

In addition to the reinforcing fiber and the high strength toughening fiber, the nonwoven fibrous mat can further include a thermoplastic fiber comprising a polyetherimide, a polyetherimide sulfone, a polyphenylene sulfide, a polyetheretherketone, a poly(p-phenylene-2,6-benzobisoxazole) (PBO), a polytetrafluoroethylene (PTFE), or a combination thereof. For example, the nonwoven fibrous mat can preferably further comprise polyetherimide fibers (i.e., fibers comprising a polyetherimide).

Polyetherimides comprise more than 1, for example 2 to 1000, or 5 to 500, or 10 to 100 structural units of the formula

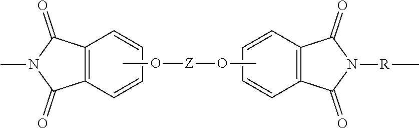

wherein each R is independently the same or different, and is a substituted or unsubstituted divalent organic group, such as a substituted or unsubstituted C₆₋₂₀ aromatic hydrocarbon group, a substituted or unsubstituted straight or branched chain C₄₂₀ alkylene group, a substituted or unsubstituted C₃₋₈ cycloalkylene group, in particular a halogenated derivative of any of the foregoing. In some embodiments R is divalent group of one or more of the following formulas

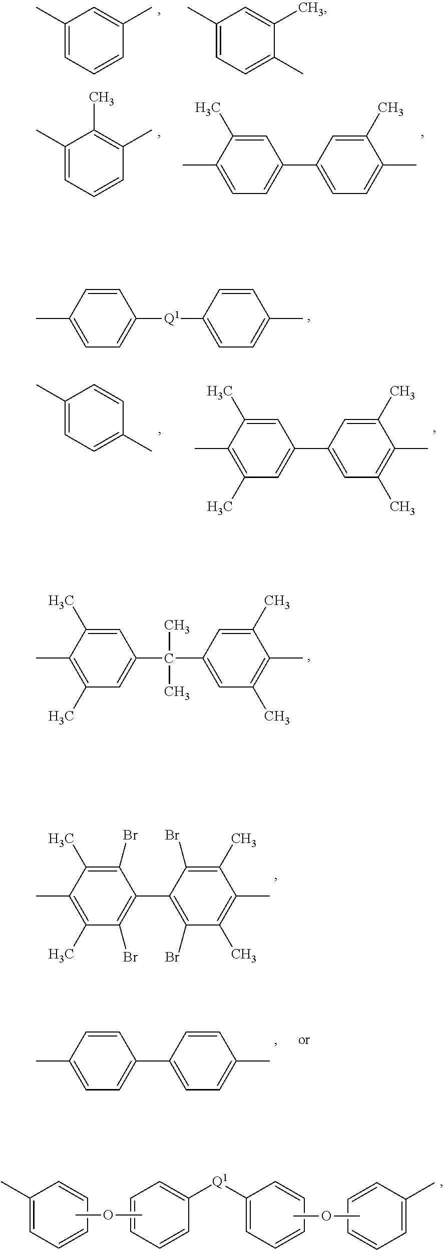

wherein Q¹ is —O—, —S—, —C(O)—, —SO₂—, —SO—, —P(R^{a})(═O)— wherein R^{a} is a C₁₋₈ alkyl or C₆₋₁₂ aryl, —C_{y}H2_{y}— wherein y is an integer from 1 to 5 or a halogenated derivative thereof (which includes perfluoroalkylene groups), or —(C6H₁O)_{z}— wherein z is an integer from 1 to 4. In some embodiments R is m-phenylene, p-phenylene, or a diarylene sulfone, in particular bis(4,4′-phenylene)sulfone, bis(3,4′-phenylene)sulfone, bis(3,3′-phenylene)sulfone, or a combination comprising at least one of the foregoing. In some embodiments, at least 10 mole percent or at least 50 mole percent of the R groups contain sulfone groups, and in other embodiments no R groups contain sulfone groups.

The divalent bonds of the —O—Z—O— group are in the 3,3′, 3,4′, 4,3′, or the 4,4′ positions, and Z is a group of the formula

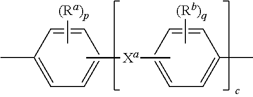

wherein R^{a} and R^{b} are each independently the same or different, and are a halogen atom or a monovalent C₁₋₆ alkyl group, for example; p and q are each independently integers of 0 to 4; c is 0 to 4; and X^{a} is a bridging group connecting the hydroxy-substituted aromatic groups, where the bridging group and the hydroxy substituent of each C₆ arylene group are disposed ortho, meta, or para (specifically para) to each other on the C₆ arylene group. The bridging group X^{a} can be a single bond, —O—, —S—, —S(O)—, —S(O)₂—, —C(O)—, or a C₁₋₁₈ organic bridging group. The C₁₋₁₈ organic bridging group can be cyclic or acyclic, aromatic or non-aromatic, and can further comprise heteroatoms such as halogens, oxygen, nitrogen, sulfur, silicon, or phosphorous. The C₁₋₁₈ organic group can be disposed such that the C₆ arylene groups connected thereto are each connected to a common alkylidene carbon or to different carbons of the C₁₋₁₈ organic bridging group. A specific example of a group Z is a divalent group of the formula

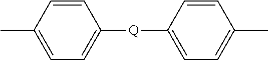

wherein Q is —O—, —S—, —C(O)—, —SO₂—, —SO—, —P(R^{a})(═O)— wherein R^{a} is a C₁₋₈ alkyl or C₆₋₁₂ aryl, or —C_{y}H₂— wherein y is an integer from 1 to 5 or a halogenated derivative thereof (including a perfluoroalkylene group). In a specific embodiment Z is a derived from bisphenol A, such that Q is 2,2-isopropylidene.

Alternatively, R is m-phenylene, p-phenylene, or a combination comprising at least one of the foregoing, and Z is a divalent group of the formula

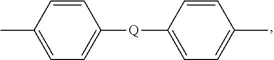

wherein Q is 2,2-isopropylidene. Alternatively, the polyetherimide can be a copolymer comprising additional structural polyetherimide units wherein at least 50 mole percent (mol %) of the R groups are bis(4,4′-phenylene)sulfone, bis(3,4′-phenylene)sulfone, bis(3,3′-phenylene)sulfone, or a combination comprising at least one of the foregoing and the remaining R groups are p-phenylene, m-phenylene or a combination comprising at least one of the foregoing; and Z is 2,2-(4-phenylene)isopropylidene, i.e., a bisphenol A moiety.

In some embodiments, the polyetherimide is not halogenated. Stated another way, in some embodiments, the polyetherimide does not contain any halogens.

In some embodiments, the polyetherimide is a copolymer that optionally comprises additional structural imide units that are not polyetherimide units, for example imide units of the formula

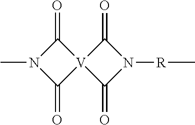

wherein R is as described above and each V is the same or different, and is a substituted or unsubstituted C₆₋₂₀ aromatic hydrocarbon group, for example a tetravalent linker of the formulas

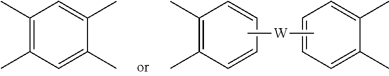

wherein W is a single bond, —O—, —S—, —C(O)—, —SO₂—, —SO—, a C₁₋₁₈ hydrocarbylene group, —P(R^{a})(═O)— wherein R^{a} is a C₁₋₈ alkyl or C₆₋₁₂ aryl, or —C_{y}H_{2y}— wherein y is an integer from 1 to 5 or a halogenated derivative thereof (which includes perfluoroalkylene groups). These additional structural imide units preferably comprise less than 20 mol % of the total number of units, and more preferably can be present in amounts of 0 to 10 mol % of the total number of units, or 0 to 5 mol % of the total number of units, or 0 to 2 mol % of the total number of units. In some embodiments, no additional imide units are present in the polyetherimide.

The polyetherimide can be prepared by any of the methods known to those skilled in the art, including the reaction of an aromatic bis(ether anhydride) of the formula

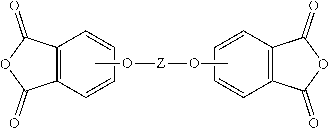

or a chemical equivalent thereof, with an organic diamine of the formula H₂N—R—NH₂, wherein Z and R are defined as described above. Copolymers of the polyetherimides can be manufactured using a combination of an aromatic bis(ether anhydride) of the above formula and an additional bis(anhydride) that is not a bis(ether anhydride), for example pyromellitic dianhydride or bis(3,4-dicarboxyphenyl) sulfone dianhydride.

Illustrative examples of aromatic bis(ether anhydride)s include 2,2-bis[4-(3,4-dicarboxyphenoxy)phenyl]propane dianhydride (also known as bisphenol A dianhydride or BPADA), 3,3-bis[4-(3,4-dicarboxyphenoxy)phenyl]propane dianhydride; 4,4′-bis(3,4-dicarboxyphenoxy)diphenyl ether dianhydride; 4,4′-bis(3,4-dicarboxyphenoxy)diphenyl sulfide dianhydride; 4,4′-bis(3,4-dicarboxyphenoxy)benzophenone dianhydride; 4,4′-bis(3,4-dicarboxyphenoxy)diphenyl sulfone dianhydride; 4,4′-bis(2,3-dicarboxyphenoxy)diphenyl ether dianhydride; 4,4′-bis(2,3-dicarboxyphenoxy)diphenyl sulfide dianhydride; 4,4′-bis(2,3-dicarboxyphenoxy)benzophenone dianhydride; 4,4′-bis(2,3-dicarboxyphenoxy)diphenyl sulfone dianhydride; 4-(2,3-dicarboxyphenoxy)-4′-(3,4-dicarboxyphenoxy)diphenyl-2,2-propane dianhydride; 4-(2,3-dicarboxyphenoxy)-4′-(3,4-dicarboxyphenoxy)diphenyl ether dianhydride; 4-(2,3-dicarboxyphenoxy)-4′-(3,4-dicarboxyphenoxy)diphenyl sulfide dianhydride; 4-(2,3-dicarboxyphenoxy)-4′-(3,4-dicarboxyphenoxy)benzophenone dianhydride; 4,4′-(hexafluoroisopropylidene)diphthalic anhydride; and 4-(2,3-dicarboxyphenoxy)-4′-(3,4-dicarboxyphenoxy)diphenyl sulfone dianhydride. A combination of different aromatic bis(ether anhydride)s can be used.

Examples of organic diamines include 1,4-butane diamine, 1,5-pentanediamine, 1,6-hexanediamine, 1,7-heptanediamine, 1,8-octanediamine, 1,9-nonanediamine, 1,10-decanediamine, 1,12-dodecanediamine, 1,18-octadecanediamine, 3-methylheptamethylenediamine, 4,4-dimethylheptamethylenediamine, 4-methylnonamethylenediamine, 5-methylnonamethylenediamine, 2,5-dimethylhexamethylenediamine, 2,5-dimethylheptamethylenediamine, 2, 2-dimethylpropylenediamine, N-methyl-bis (3-aminopropyl) amine, 3-methoxyhexamethylenediamine, 1,2-bis(3-aminopropoxy) ethane, bis(3-aminopropyl) sulfide, 1,4-cyclohexanediamine, bis-(4-aminocyclohexyl) methane, m-phenylenediamine, p-phenylenediamine, 2,4-diaminotoluene, 2,6-diaminotoluene, m-xylylenediamine, p-xylylenediamine, 2-methyl-4,6-diethyl-1,3-phenylene-diamine, 5-methyl-4,6-diethyl-1,3-phenylene-diamine, benzidine, 3,3′-dimethylbenzidine, 3,3′-dimethoxybenzidine, 1,5-diaminonaphthalene, bis(4-aminophenyl) methane, bis(2-chloro-4-amino-3,5-diethylphenyl) methane, bis(4-aminophenyl) propane, 2,4-bis(p-amino-t-butyl) toluene, bis(p-amino-t-butylphenyl) ether, bis(p-methyl-o-aminophenyl) benzene, bis(p-methyl-o-aminopentyl) benzene, 1, 3-diamino-4-isopropylbenzene, bis(4-aminophenyl) sulfide, bis-(4-aminophenyl) sulfone (also known as 4,4′-diaminodiphenyl sulfone (DDS)), and bis(4-aminophenyl) ether. Any regioisomer of the foregoing compounds can be used. C₁₋₄ alkylated or poly(C₁₋₄alkylated derivatives of any of the foregoing can be used, for example a polymethylated 1,6-hexanediamine. Combinations of these compounds can also be used. In some embodiments the organic diamine is m-phenylenediamine, p-phenylenediamine, 4,4′-diaminodiphenyl sulfone, 3,4′-diaminodiphenyl sulfone, 3,3′-diaminodiphenyl sulfone, or a combination comprising at least one of the foregoing.

The polyetherimides can have a melt index of 0.1 to 10 grams per minute (g/min), as measured by American Society for Testing Materials (ASTM) D1238 at 340 to 370° C., using a 6.6 kilogram (kg) weight. In some embodiments, the polyetherimide used to prepare the thermoplastic fiber can have a weight average molecular weight (Mw) of 10,000 to 150,000 grams/mole (Daltons), as measured by gel permeation chromatography, using polystyrene standards. In some embodiments the polyetherimide has an Mw of 20,000 to 80,000 Daltons. Such polyetherimides typically have an intrinsic viscosity greater than 0.2 deciliters per gram (dl/g), or, more specifically, 0.35 to 0.7 dl/g as measured in m-cresol at 25° C.

When present, the thermoplastic fiber can be included in the nonwoven fibrous mat in an amount of 20 to 80 weight percent, or 40 to 80 weight percent, or 40 to 70 weight percent, or 40 to 60 weight percent, or 45 to 55 weight percent, or about 50 weight percent, based on the total weight of the nonwoven fibrous mat.

In addition to the reinforcing fiber, the high strength toughening fiber, and the thermoplastic fiber, the nonwoven fibrous mat can further include a binder, which can be in fiber form or can be obtained in solution form. Suitable materials for the binder can preferably include low melting temperature materials that can at least partially melt to bond other fiber components together at a point of contact between the fibers during the consolidation process. Preferably, the binder can be a binder fiber. Useful binders can include polycarbonate (including polycarbonate copolymers), polyalkylene terephthalate, polyamide, polypropylene, or a combination comprising at least one of the foregoing. In some embodiments, a binder fiber preferably comprises polycarbonate.

“Polycarbonate” as used herein means a polymer or copolymer having repeating structural carbonate units of the formula

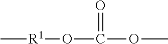

wherein at least 60 percent of the total number of R¹ groups are aromatic, or each R¹ contains at least one C₆₋₃₀ aromatic group. Polycarbonates and their methods of manufacture are known in the art, being described, for example, in WO 2013/175448 A1, US 2014/0295363, and WO 2014/072923. Polycarbonates are generally manufactured from bisphenol compounds such as 2,2-bis(4-hydroxyphenyl) propane (“bisphenol-A” or “BPA”), 3,3-bis(4-hydroxyphenyl) phthalimidine, 1,1-bis(4-hydroxy-3-methylphenyl)cyclohexane, or 1,1-bis(4-hydroxy-3-methylphenyl)-3,3,5-trimethylcyclohexane, or a combination comprising at least one of the foregoing bisphenol compounds can also be used. In a specific embodiment, the polycarbonate is a homopolymer derived from BPA; a copolymer derived from BPA and another bisphenol or dihydroxy aromatic compound such as resorcinol; or a copolymer derived from BPA and optionally another bisphenol or dihydroxyaromatic compound, and further comprising non-carbonate units, for example aromatic ester units such as resorcinol terephthalate or isophthalate, aromatic-aliphatic ester units based on C₆₋₂₀ aliphatic diacids, polysiloxane units such as polydimethylsiloxane units, or a combination comprising at least one of the foregoing. “Polycarbonate” as used herein includes homopolycarbonates (wherein each R¹ in the polymer is the same), copolymers comprising different R¹ moieties in the carbonate units (referred to herein as “copolycarbonates”), copolymers comprising carbonate units and other types of polymer units, such as ester units, and combinations comprising homopolycarbonate or copolycarbonate. As used herein, a “combination” is inclusive of blends, mixtures, alloys, reaction products, and the like.

The binder fiber can be present in the nonwoven fibrous mat in an amount of 0 to 20 weight percent, or 5 to 15 weight percent, or about 10 weight percent, based on the total weight of the nonwoven fibrous mat.

In some embodiments, the nonwoven fibrous mat comprises the high strength toughening fiber and the thermoplastic fiber, for example 30 to 55 weight percent, or 45 to 55 weight percent of the high strength toughening fiber and 45 to 70 weight percent, or 45 to 55 weight percent of the thermoplastic fiber, each based on the total weight of the nonwoven fibrous mat In a specific embodiment, the nonwoven fibrous mat comprises 3 to 30 weight percent of a reinforcing fiber comprising carbon fiber, 5 to 55 weight percent of a high strength toughening fiber comprising an aromatic polyamide, 20 to 80 weight percent of a polyetherimide fiber, and 0 to 20 weight percent of a binder fiber comprising a polycarbonate fiber, wherein weight percent of each component is based on the total weight of the nonwoven fibrous mat. In another specific embodiment, the nonwoven fibrous mat comprises 10 to 20 weight percent of a reinforcing fiber comprising carbon fiber, 20 to 30 weight percent of a high strength toughening fiber comprising an aromatic polyamide, 45 to 55 weight percent of a polyetherimide fiber, and 5 to 15 weight percent of a binder fiber comprising a polycarbonate fiber, wherein weight percent of each component is based on the total weight of the nonwoven fibrous mat.

The fibrous mat can be made using known paper making techniques, such as on cylinder or Fourdrinier paper making machines. In general, fibers are chopped and refined to obtain the proper fiber length (e.g., 12 millimeters or less). The desired fibers are added to water to form a mixture of fibers and water. The mixture then is screened to drain the water from the mixture to form a sheet of paper. The screen tends to orient the fibers in the direction in which the sheet is moving, which is referred to as the machine direction. Consequently, the resulting paper has a greater tensile strength in the machine direction than in the perpendicular direction, which is referred to as the cross direction. The sheet of paper is fed from the screen onto rollers and through other processing equipment that removes the water in the paper.

The fibrous mat can be prepared at an aereal density of 5 to 200 GSM (grams per square meter), specifically 30 to 120 GSM, and more specifically 40 to 80 GSM. The fibrous mat further has sufficient porosity to allow penetration or impregnation by a varnish which can reinforce the paper, as will be discussed in further detail below.

The fibrous mat can generally be prepared in any thickness suitable for the intended application. In general, consistent thickness is desirable. The average thickness of the mat can be more than 0 to less than 2 millimeters, or more than 0 to less than 1 millimeter, or more than 0 to 800 micrometers (μm), or 10 to 500 μm, or 20 to less than 300 μm.

The nonwoven fibrous mat can be unconsolidated or consolidated. An unconsolidated fibrous mat refers to the fibrous mat as spun. The unconsolidated fibrous mat can optionally be further processed, for example, to provide the corresponding consolidated fibrous mat. For example, the unconsolidated mat can be consolidated by the application of heat and pressure to form a consolidated fibrous mat. Consolidation of the fibrous mat can be achieved, for example, by a continuous process such as an isobaric double belt lamination process, an isochoric double belt lamination process, or a calendering process. In some embodiments, consolidation can be carried out using an isobaric double belt process at a temperature of 200 to 400° C., a pressure of 50 to 70 bars, and using a belt speed of 3 to 9 meters per minute, and a total residence time of 1 to 3 minutes. In some embodiments, the consolidated fibrous mat can have a reduced porosity relative to the unconsolidated fibrous mat. Preferably, during consolidation, the fibers remain substantially unmelted. In some embodiments, the thermoplastic fiber, the binder fiber, or both, can be at least partially melted during consolidation. In some embodiments, the binder fibers can at least partially melt at a point of contact with one or more of the reinforcing fibers, the high strength toughening fibers, and the thermoplastic fibers.

The nonwoven fibrous mat of the reinforced paper of the present disclosure is impregnated with a polyetherimide composition. The polyetherimide composition can be present in an amount effective to provide an improvement in at least one property of the paper. For example, the polyetherimide composition can be present in an amount effective to reduce water absorption, to improve the mechanical strength, or both. In some embodiments, the reinforced paper comprises the nonwoven fibrous mat and the polyetherimide composition in a weight ratio of 1:0.01 to 1:5. Within that range, the nonwoven fibrous mat and the polyetherimide composition can be present in a weight ratio of 1:0.01 to 1:2, or 1:0.01 to 1:1.25, or 1:0.01 to 1:1, or 1:0.01 to 1:0.5, or 1:0.01 to 1:0.25. Preferably, the nonwoven fibrous mat and the polyetherimide composition can be present in a weight ratio of 1:0.01 to 1:0.1, or 1:0.01 to 1:0.05, or 1:0.02 to 1:0.05. More preferably, the nonwoven fibrous mat and the polyetherimide composition can be present in a weight ratio of 1:05 to 1:3, or 1:0.5 to 1:2, or 1:1 to 1:2.

The impregnation of the polyetherimide composition into the nonwoven fibrous mat can be characterized, for example, by the porosity of the impregnated fibrous mat relative to the initial fibrous mat. For example, in some embodiments, impregnating the fibrous mat with the polyetherimide composition results in less than a 50%, or a 5 to 50%, or a 10 to 50% reduction in porosity of the fibrous mat. In other embodiments, impregnating the fibrous mat with the polyetherimide composition results in a 50% or greater, or 50 to 99%, or 60 to 95%, or 80 to 90% reduction in the porosity of the fibrous mat. Porosity of the fibrous mat can be determined according to methods that are generally known in the art, for example by measuring the air permeance of the fibrous mat according to the Gurley method, for example according to ISO 5636-5 or TAPPI T460.

The polyetherimide composition comprises a polyetherimide, which can be as described above. In some embodiments, the polyetherimide can have structural units according to the above formula, wherein each occurrence of R is independently a substituted or unsubstituted C₆₋₂₀ aromatic hydrocarbon group, a substituted or unsubstituted straight or branched chain C₄₋₂₀ alkylene group, a substituted or unsubstituted C₃₋₈ cycloalkylene group, or a combination thereof, and each occurrence of Z is independently an aromatic C₆₋₂₄ monocyclic or polycyclic group optionally substituted with 1 to 6 C₁₋₈ alkyl groups, 1 to 8 halogen atoms, or a combination thereof. In some embodiments, Z is 4,4′-diphenylene isopropylidene and R is para-phenylene, meta-phenylene, or a combination thereof. For example, Z can be 4,4′-diphenylene isopropylidene and R can be para-phenylene or Z can be 4,4′-diphenylene isopropylidene and R can be meta-phenylene. In some embodiments, the polyetherimide is nonhalogenated. Stated another way, in some embodiments, the polyetherimide does not contain any halogens (i.e., does not contain any halogen substituents).

Advantageously, the polyetherimide of the polyetherimide composition can have a high molecular weight. For example, in some embodiments, the polyetherimide of the polyetherimide composition can have a weight average molecular weight (Mw) of greater than 10,000 grams/mole (g/mole), as measured by gel permeation chromatography, using polystyrene standards. In some embodiments the polyetherimide has an Mw of 20,000 to 150,000 grams/mole, preferably 40,000 to 150,000 grams/mole, more preferably 45,000 to 100,000 grams/mole, even more preferably 50,000 to 90,000 grams/mole, most preferably 60,000 to 80,000 grams/mole.

Optionally, the nonwoven fibrous mat can further be impregnated with a poly(phenylene ether) comprising structural units according to the formula

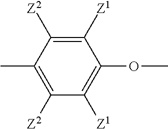

wherein for each repeating unit, each Z¹ is independently halogen, unsubstituted or substituted C₁-C₁₂ hydrocarbyl provided that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms; and each Z² is independently hydrogen, halogen, unsubstituted or substituted C₁-C₁₂ hydrocarbyl provided that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atom. In some embodiments, the poly(phenylene ether) comprises 2,6-dimethyl-1,4-phenylene ether repeating units, that is, repeating units having the structure

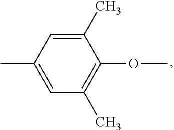

2,3,6-trimethyl-1,4-phenylene ether repeating units, 2-methyl-6-phenyl-1,4-phenylene ether repeating units, or a combination thereof. In a specific embodiment, the poly(phenylene ether) is a copolymer comprising 2,6-dimethyl-1,4-phenylene ether repeating units and 2-methyl-6-phenyl-1,4-phenylene ether repeating units. As will be discussed below, such a copolymer allows for the use solvents such as N-methyl-2-pyrrolidone, which can be advantageous.

The poly(phenylene ether) can be a homopolymer, a copolymer, a graft copolymer, an ionomer, a block copolymer, or a combination thereof. The poly(phenylene ether) can comprise, for example 2,6-dimethyl-1,4-phenylene ether repeating units, 2,3,6-trimethyl-1,4-phenylene ether repeating units, 2-methyl-6-phenyl-1,4-phenylene ether repeating units, or a combination thereof. The poly(phenylene ether) can be monofunctional or bifunctional. In some embodiments, the poly(phenylene ether) can be monofunctional. For example, it can have a functional group at one terminus of the polymer chains. The functional group can be, for example, a hydroxyl group or a (meth)acrylate group, preferably a hydroxyl group. In some embodiments, the poly(phenylene ether) comprises poly(2,6-dimethyl-1,4-phenylene ether). An example of a monofunctional poly(2,6-dimethyl-1,4-phenylene ether) oligomer is NORYL™ Resin SA120, available from SABIC Innovative Plastics.

In some embodiment, the poly(phenylene ether) can be bifunctional. For example, it can have functional groups at both termini of the polymer chain. The functional groups can be, for example, hydroxyl groups or (meth)acrylate groups, preferably hydroxyl groups. Bifunctional polymers with functional groups at both termini of the polymer chains are also referred to as “telechelic” polymers. In some embodiments, the poly(phenylene ether) comprises a bifunctional poly(phenylene ether) having the structure

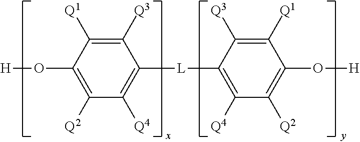

wherein Q¹ and Q² are each independently halogen, unsubstituted or substituted C₁-C₁₂ primary or secondary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms; each occurrence of Q³ and Q⁴ is independently hydrogen, halogen, unsubstituted or substituted C₁-C₁₂ primary or secondary hydrocarbyl, C₁-C₁₂ hydrocarbylthio, C₁-C₁2 hydrocarbyloxy, or C₂-C₁₂ halohydrocarbyloxy wherein at least two carbon atoms separate the halogen and oxygen atoms; x and y are independently 0 to 30, specifically 0 to 20, more specifically 0 to 15, still more specifically 0 to 10, even more specifically 0 to 8, provided that the sum of x and y is at least 2, specifically at least 3, more specifically at least 4; and L has the structure

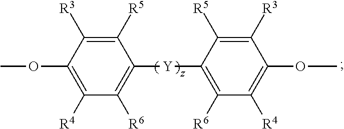

wherein each occurrence of R³ and R⁴ and R⁵ and R⁶ is independently hydrogen, halogen, unsubstituted or substituted C₁-C₁₂ primary or secondary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms; z is 0 or 1; and Y has a structure

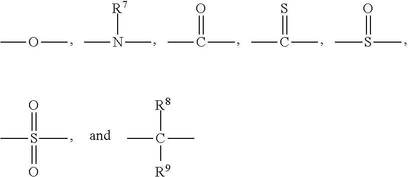

wherein each occurrence of R⁷ is independently hydrogen or C₁-C₁₂ hydrocarbyl, and each occurrence of R⁸ and R⁹ is independently hydrogen, C₁-C₁₂ hydrocarbyl, or C₁-C₆ hydrocarbylene wherein R⁸ and R⁹ collectively form a C₄-C₁₂ alkylene group.

In the hydroxy-terminated phenylene ether structure above, there are limitations on the variables x and y, which correspond to the number of phenylene ether repeating units at two different places in the bifunctional poly(phenylene ether). In the structure, x and y are independently 0 to 30, specifically 0 to 20, more specifically 0 to 15, even more specifically 0 to 10, yet more specifically 0 to 8. The sum of x and y is at least 2, specifically at least 3, more specifically at least 4. A poly(phenylene ether) can be analyzed by proton nuclear magnetic resonance spectroscopy (¹H NMR) to determine whether these limitations are met, on average. Specifically, ¹H NMR can distinguish between protons associated with internal and terminal phenylene ether groups, with internal and terminal residues of a polyhydric phenol, and with terminal residues as well. It is therefore possible to determine the average number of phenylene ether repeating units per molecule, and the relative abundance of internal and terminal residues derived from dihydric phenol.

In some embodiments the poly(phenylene ether) comprises a bifunctional phenylene ether oligomer having the structure

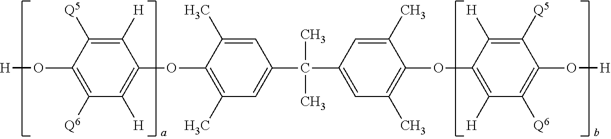

wherein each occurrence of Q⁵ and Q⁶ is independently methyl, di-n-butylaminomethyl, or morpholinomethyl; and each occurrence of a and b is independently 0 to 20, with the proviso that the sum of a and b is at least 2. An exemplary bifunctional phenylene ether oligomer includes NORYL™ Resin SA90, available from SABIC Innovative Plastics.

The poly(phenylene ether) can comprise rearrangement products, such as bridging products and branching products. For example, poly(2,6-dimethyl-1,4-phenylene ether) can comprise the bridging fragment below:

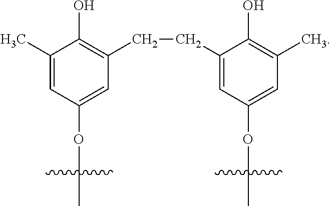 [SMILES: *Oc1cc(C)c(O)c(CCc2cc(O*)cc(C)c2O)c1]

This branching fragment is referred to herein as an “ethylene bridge group”. As another example, poly(2,6-dimethyl-1,4-phenylene ether) can comprise the branching fragment below:

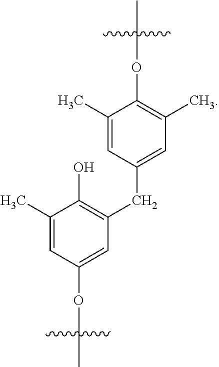 [SMILES: *Oc1cc(C)c(O)c(Cc2cc(C)c(O*)c(C)c2)c1]

This branching fragment is referred to herein as a “rearranged backbone group”. These fragments can be identified and quantified by ³¹P nuclear magnetic resonance spectroscopy after phosphorus derivatization of the hydroxyl groups.

The poly(phenylene ether) can be essentially free of incorporated diphenoquinone residues. In the context, “essentially free” means that the fewer than 1 weight percent of phenylene ether oligomer molecules comprise the residue of a diphenoquinone. As described in U.S. Pat. No. 3,306,874 to Hay, synthesis of poly(phenylene ether) by oxidative polymerization of monohydric phenol yields not only the desired poly(phenylene ether) but also a diphenoquinone as side product. For example, when the monohydric phenol is 2,6-dimethylphenol, 3,3′,5,5′-tetramethyldiphenoquinone is generated. Typically, the diphenoquinone is “reequilibrated” into the poly(phenylene ether) (i.e., the diphenoquinone is incorporated into the poly(phenylene ether) chain) by heating the polymerization reaction mixture to yield a poly(phenylene ether) comprising terminal or internal diphenoquinone residues. For example, as shown in the Scheme below, when a poly(phenylene ether) is prepared by oxidative polymerization of 2,6-dimethylphenol to yield poly(2,6-dimethyl-1,4-phenylene ether) and 3,3′,5,5′-tetramethyldiphenoquinone, reequilibration of the reaction mixture can produce a poly(phenylene ether) with terminal and internal residues of diphenoquinone. Thus, the Scheme below illustrates one method for the preparation of a difunctional phenylene ether oligomer.

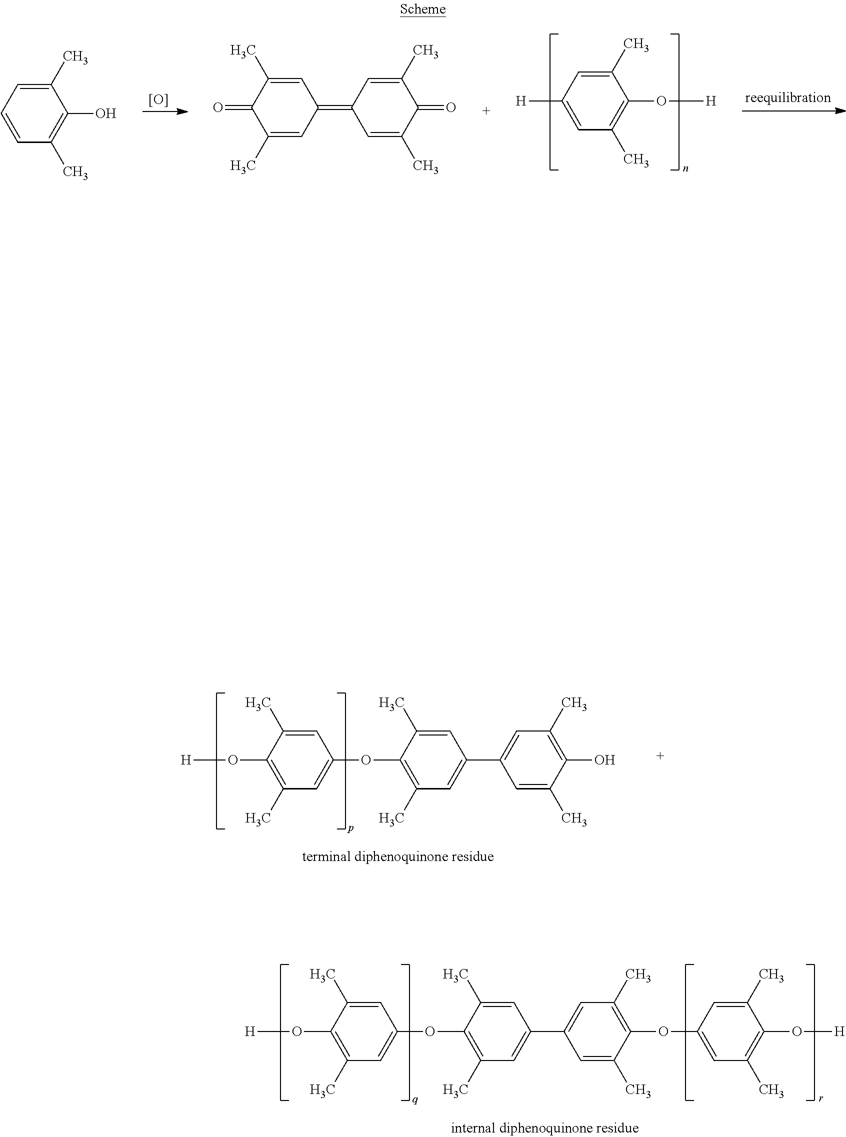

In some embodiments, particularly when a bifunctional poly(phenylene ether) or bifunctional phenylene ether oligomer is used to impregnate the nonwoven fibrous mat, a multifunctional epoxy can be used to cure the bifunctional poly(phenylene ether) or bifunctional phenylene ether oligomer, increasing the molecular weight of the polymer through formation of a crosslinked network. For example, a bifunctional epoxy material can be particularly useful. Exemplary bifunctional epoxy materials can include an oligomeric bisphenol diglycidyl ether of the structure

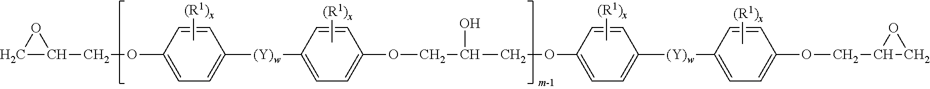

wherein m is an integer from 1 to 10, R¹ is halogen, C₁-C₁₂ hydrocarbylthio, C₁-C₁₂ hydrocarbyloxy, C₂-C₁₂ halohydrocarbyloxy wherein at least two carbon atoms separate the halogen and oxygen atoms, or unsubstituted or substituted C₁-C₁₂ hydrocarbyl, w is 0 or 1, x is independently 0, 1, 2, 3, or 4, and Y is independently

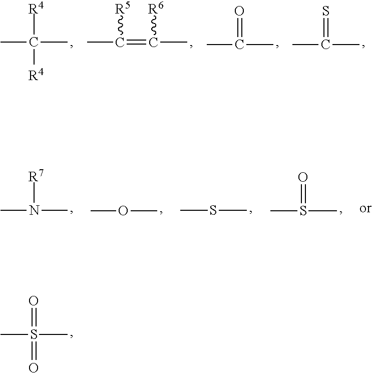

wherein each occurrence of R⁴, R⁵, R⁶, and R⁷ is independently hydrogen or an unsubstituted or substituted C₁-C₁₂ hydrocarbyl. An example of a suitable bifunctional epoxy that can be used as a crosslinker includes bisphenol A diglycidyl ether, available as D.E.R. 332 from Dow.

In some embodiments, polymers other than the polyetherimide and the poly(phenylene ether) can be excluded from the composition impregnating the nonwoven fibrous mat. For example, less than 1 weight percent, preferably less than 0.5 weight percent, more preferably less than 0.1 weight percent of any polymer other than the polyetherimide and the poly(phenylene ether) impregnates the nonwoven fibrous mat.

The polyetherimide composition can optionally further comprise one or more additives, with the proviso that the one or more additives do not significantly adversely affect the desired properties of the reinforced paper. For example, the polyetherimide composition can further comprise a plasticizer effective to reduce the brittleness of the material and reduce the processing (polymerization) temperature (e.g., glycerol tristearate (GTS), phthalic acid esters (e.g, octyl-4,5-epoxy-hexahydrophthalate), tris-(octoxycarbonylethyl)isocyanurate, tristearin, di- or polyfunctional aromatic phosphates (e.g, resorcinol tetraphenyl diphosphate (RDP), the bis(diphenyl) phosphate of hydroquinone and the bis(diphenyl) phosphate of bisphenol A), poly-alpha-olefins, epoxidized soybean oil, silicones, including silicone oils (e.g., poly(dimethyl diphenyl siloxanes), esters, for example, fatty acid esters (e.g, alkyl stearyl esters, such as, methyl stearate, stearyl stearate, and the like), waxes (e.g, beeswax, montan wax, paraffin wax, or the like), or combinations thereof, preferably an aromatic phosphate, in particular, resorcinol tetraphenyl diphosphate (for example, FYROLFLEX RDP, available from ICL Industrial Products)), a filler (e.g., a particulate polytetrafluoroethylene (PTFE), glass, carbon, mineral or metal), a reinforcing agent, a colorant (e.g., a dye or pigment), a surface effect additive, a flame retardant (e.g., halogenated or phosphorus-containing flame retardants including resorcinol diphosphate, bisphenol A diphosphate, tetraxylyl piperazine diphosphamide, and the like, or a combination comprising at least one of the foregoing), an anti-drip agent (e.g., a PTFE-encapsulated styrene-acrylonitrile copolymer (TSAN)), or a combination comprising at least one of the foregoing additives. The additives can be present in the polyetherimide composition in amounts that are generally known to be effective, for example, the total amount of additives (other than any filler or reinforcing agent) can be 0.001 to 30 weight percent, or 0.01 to 15 weight percent, or 0.01 to 10 weight percent, or 0.01 to 5 weight percent, each based on the total weight of the polyetherimide composition.

The polyetherimide composition can have low levels of residual volatile species. Examples of such volatile species are halogenated aromatic compounds such as chlorobenzene, dichlorobenzene, trichlorobenzene, aprotic polar solvents such as dimethyl formamide (DMF), N-methyl pyrrolidone (NMP), dimethyl sulfoxide (DMSO), diaryl sulfones, sulfolane, pyridine, phenol, veratrole, anisole, cresols, xylenols, dichloroethanes, tetrachloroethanes, pyridine, alcoholic solvents, water, or combinations thereof. For example, the polyetherimide composition can have a residual volatile species concentration of less than 1,000 parts by weight per million parts by weight (ppm), or less than 500 ppm, or less than 300 ppm, or less than 100 ppm. In some embodiments, the polyetherimide composition can be devoid of, or exclude, any residual volatile species.

In some embodiments, the polyetherimide composition is halogen-free.

The reinforced paper can have a particular structure or geometry that can be selected depending on the desired application. For example, the paper can be a flat paper sheet, or a corrugated paper. In some embodiments, the reinforced paper can have a folded cell configuration or structure. For example, the paper can have an open cell structure, in particular, a honeycomb structure comprising a plurality of interconnected walls that define a plurality of open cells or voids (e.g., honeycomb cells). The interconnected walls of the open cell paper can comprise the nonwoven fibrous mat, described above. The paper can also have a closed cell structure. The folded cells can have a variety of shapes, for example, a hexagonal shape, a square shape, a rectangular shape, a triangular shape, or a combination comprising at least one of the foregoing. Typically, the folded cells can have a hexagonal shape, though a wide range of folded cell configurations and sizes are contemplated for use in the reinforced paper of the present disclosure. In some embodiments, the folded cell configuration can be a regular or irregular pattern created by folding the paper into various patterns.

Another aspect of the present disclosure is a method of making the reinforced paper. The method comprises contacting at least a portion of a nonwoven fibrous mat with an impregnating composition to form a pre-preg. The nonwoven fibrous mat can be as described above, and can include a reinforcing fiber, a high strength toughening fiber or a combination comprising at least one of the foregoing. The fibrous mat can further include a thermoplastic fiber, a binder fiber, or a combination thereof. In a specific embodiment, the nonwoven fibrous mat comprises 3 to 30 weight percent of a reinforcing fiber comprising carbon fiber, 5 to 55 weight percent of a high strength toughening fiber comprising an aromatic polyamide, 20 to 80 weight percent of a polyetherimide fiber, and 0 to 20 weight percent of a binder fiber comprising a polycarbonate fiber, wherein weight percent of each component is based on the total weight of the nonwoven fibrous mat. In another specific embodiment, the nonwoven fibrous mat comprises 10 to 20 weight percent of a reinforcing fiber comprising carbon fiber, 20 to 30 weight percent of a high strength toughening fiber comprising an aromatic polyamide, 45 to 55 weight percent of a polyetherimide fiber, and 5 to 15 weight percent of a binder fiber comprising a polycarbonate fiber, wherein weight percent of each component is based on the total weight of the nonwoven fibrous mat.

The nonwoven fibrous mat can be folded or formed into a particular structure or geometry depending on the desired application, as described above. In some embodiments, the nonwoven fibrous mat has the desired structure, for example, a honeycomb or other folded cell structure, prior to being impregnated with the impregnating composition. In some embodiments, the nonwoven fibrous mat can be contacted with the impregnating composition as described below to form a reinforced paper, and the reinforced paper can subsequently be folded or formed into a reinforced paper having a particular structure or geometry (e.g., a honeycomb or other folded cell structure).

Contacting of the nonwoven fibrous mat and the impregnating composition can be by any means that are generally known, for example, spray coating, dip coating, flow coating, soaking, and the like, or a combination thereof. In some embodiments, heat, pressure, or both can be applied to consolidate the fibrous mat and the impregnating composition.

The impregnating composition comprises a solvent and a polyetherimide, a polyamic acid salt, or a combination thereof. The polyetherimide can be as described above. For example, the polyetherimide can have structural units where each occurrence of R is independently a substituted or unsubstituted C₆₋₂₀ aromatic hydrocarbon group, a substituted or unsubstituted straight or branched chain C₄₋₂₀ alkylene group, a substituted or unsubstituted C₃₋₈ cycloalkylene group, or a combination thereof, and each occurrence of Z is independently an aromatic C₆₋₂₄ monocyclic or polycyclic group optionally substituted with 1 to 6 C₁₋₈ alkyl groups, 1 to 8 halogen atoms, or a combination thereof. In some embodiments, Z is 4,4′-diphenylene isopropylidene and R is para-phenylene, meta-phenylene, or a combination thereof. For example, Z can be 4,4′-diphenylene isopropylidene and R can be para-phenylene or Z can be 4,4′-diphenylene isopropylidene and R can be meta-phenylene.

In some embodiments, the impregnating composition comprises a polyamic acid salt. The polyamic acid salt (also referred to as a polyetherimide prepolymer salt) comprises partially reacted units according to formulas (q) and (r) to fully reacted units of formula (s):

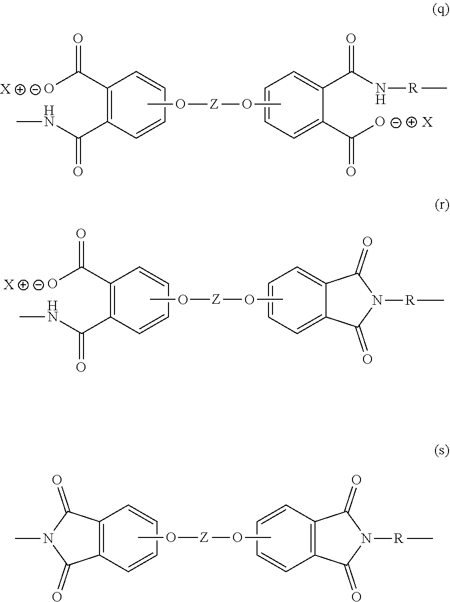

wherein Z and R are as described above, and X is a cationic counterion that can be, for example, sodium, potassium, lithium, a quaternary ammonium ion, and the like or a combination thereof, preferably a quaternary ammonium ion, for example a triethylammonium or dimethylethanolammonium. The polyamic acid salt contains at least one unit (q), 0 or 1 or more units (r), and 0 or 1 or more units (s), for example 1 to 200 or 1 to 100 or 1 to 50 units (q), 0 to 200 or 0 to 100 or 0 to 50 units (r), and 0 to 200 or 0 to 100 or 0 to 50 units (s). In some embodiments, the polyamic acid salt can have a total degree of polymerization (e.g., (q)+(r)+(s)=DP) of 100 or less, for example 1 to 100. An imidization value for the polyamic acid salt can be determined using the relationship:

(2s+r)/(2q+2r+2s)

wherein “q”, “r”, and “s” each stand for the number of units (q), (r), and (s), respectively. In some embodiments, the imidization value of the polyamic acid salt is less than or equal to 0.2, less than or equal to 0.15, or less than or equal to 0.1. In some embodiments, the polyamic acid salt has an imidization value of greater than 0.2, for example greater than 0.25, greater than 0.3, or greater than 0.5, provided that the desired solubility of the polyamic acid salt is maintained. The number of units of each type can be determined by spectroscopic methods, for example, Fourier Transform Infrared (FT-IR) spectroscopy, chromatographic methods (e.g., liquid chromatography), or a combination thereof.

The solvent of the impregnating composition can be an organic solvent or an aqueous or alcohol solvent, depending on the polymer selected for use in the impregnating composition (i.e., the polyetherimide or the polyamic acid salt). For example, when the impregnating composition comprises a polyetherimide, the solvent is an organic solvent. Exemplary organic solvents can include N-methyl-2-pyrrolidone, dimethylacetamide, tetrahydrofuran, dimethylformamide, dimethylsulfoxide, or a combination comprising at least one of the foregoing. When the impregnating composition comprises a polyamic acid salt, the solvent can advantageously comprise water, a C₁₋₆ alcohol or a combination thereof. The C₁₋₆ alkyl group of the alcohol can be linear or branched. For example, the C₁₋₆ alcohol can include methanol, ethanol, n-propanol, isopropanol, n-butanol, t-butanol, sec-butanol, 1-pentanol, 2-pentanol, 3-pentanol, 1-hexanol, 2-hexanol, 3-hexanol, 2-ethyl-1-butanol, 3-methyl-1-butanol, 3-methyl-2-butanol, 2-methyl-2-butanol, 2,2-dimethyl-1-propanol, ethylene glycol, diethylene glycol, and the like, or a combination thereof. For example, the C₁₋₆ alcohol can comprise methanol, ethanol, n-propanol, isopropanol, or a combination thereof. In an embodiment, the solvent comprises methanol, ethanol, or a combination thereof, preferably methanol.

In some embodiments, particularly (but not limited to) when the impregnating composition comprises the polyamic acid salt, the impregnating composition comprises less than 1 weight percent, or is devoid of, a chlorobenzene, dichlorobenzene, cresol, dimethylacetamide, veratrole, pyridine, nitrobenzene, methyl benzoate, benzonitrile, acetophenone, n-butyl acetate, 2-ethoxyethanol, 2-n-butoxyethanol, anisole, cyclopentanone, gamma-butyrolactone, dichloromethane or a combination thereof. In another embodiment, the impregnating composition comprises less than 1 weight percent, or less than 0.1 weight percent of a nonprotic organic solvent, and preferably the impregnating composition is devoid of a nonprotic organic solvent. In another embodiment, the impregnating composition comprises less than 1 weight percent, or less than 0.1 weight percent, of a halogenated solvent, and preferably the impregnating composition is devoid of a halogenated solvent.

The impregnating composition can include the polyetherimide, the polyamic acid salt, or combination thereof in an amount of up to 60 weight percent, based on the total weight of the solvent and the polymer, for example 1 to less than 60 weight percent of 1 to 50 weight percent, or 1 to 40 weight percent, or 1 to 30 weight percent or 1 to 20 weight percent. In some embodiments, the impregnating composition comprises the polyetherimide, the polyamic acid salt, or combination thereof in an amount of 1 to less than 15 weight percent, based on the total weight of the solvent and the polymer. Within this range, the polyetherimide, the polyamic acid salt, or combination thereof can be present in an amount of 1 to 10 weight percent, or 1 to 8 weight percent, or 2 to 7 weight percent, or 3 to 6 weight percent, based on the total weight of the solvent and the polymer.

In some embodiments, the impregnating composition further comprises an organic amine, in particular when the impregnating composition comprises the polyamic acid salt. The organic amine preferably comprises a tertiary amine in an amount effective to solubilize the polyamic acid salt in the solvent of the impregnating composition. For example, the organic amine can be present in a molar ratio of amine to polyamic acid repeat unit of about 0.8:1.2 to 1.2:0.8, or 0.9:1.1 to 1.1:0.9, or about 1:1.

The amine can be a tertiary amine of the formula R^{a}R^{b}R^{c}N, wherein each R^{a}, R^{b}, and R^{c} are the same or different and are each a substituted or unsubstituted C₁₋₁₈ hydrocarbyl. Preferably each R^{a}, R^{b}, and R^{c} are the same or different and are a substituted or unsubstituted C₁₋₁₂ alkyl, a substituted or unsubstituted C₁₋₁₂ aryl. More preferably each R^{a}, R^{b}, and R^{c} are the same or different and are an unsubstituted C₁₋₆ alkyl or a C₁₋₆ alkyl substituted with 1, 2, or 3 hydroxyl, halogen, nitrile, nitro, cyano, C₁₋₆ alkoxy, or amino groups of the formula —NR^{d}R^{e} wherein each R^{d} and R^{e} are the same or different and are a C₁₋₆ alkyl or C₁₋₆ alkoxy. Most preferably, each R^{a}, R^{b}, and R^{c} are the same or different and are an unsubstituted C₁₋₄ alkyl or a C₁₋₄ alkyl substituted with one hydroxyl, halogen, nitrile, nitro, cyano, or C₁₋₃ alkoxy. In some embodiments, the organic amine comprises triethylamine, trimethylamine, dimethylethanolamine, or a combination thereof. In some embodiments, the organic amine is preferably triethylamine, dimethylethanolamine, or a combination thereof.

The method further comprises heating the pre-preg under conditions effective to provide the reinforced paper comprising the nonwoven fibrous mat impregnated with a polyetherimide composition. This heating step can be independent of any consolidation step (i.e., the paper can be consolidated prior to heating the pre-coat). For example, heating the nonwoven fibrous mat can be at a temperature sufficient to imidize and polymerize the low molecular weight polyamic acid salt, remove the solvent, or both. Specifically, heating the impregnated nonwoven fibrous mat can be at a temperature of 120 to 400° C. Within that range, the temperature can be 150 to 300° C., or 200 to 280° C., or 220 to 270° C., or 240 to 260° C. Heating the impregnated nonwoven fibrous mat can be for a time sufficient to imidize the polyamic acid salt, remove the solvent, or both, for example, up to 24 hours, or 10 minutes to 24 hours, or 10 minutes to 10 hours, or 10 minutes to 5 hours, or 30 minutes to 2 hours.

The method can optionally further comprise repeating the steps of contacting the fibrous mat with the impregnating composition and heating. The contacting and heating can be repeated as many times as desired to achieve a particular amount of the polyetherimide composition (e.g., weight) relative to the fibrous mat. For example, the contacting and heating can be repeated in order to provide a reinforced paper comprising the nonwoven fibrous mat and the polyetherimide composition in a weight ratio of 1:0.01 to 1:5, as described above. Weight ratios of nonwoven fibrous mat to polyetherimide composition greater than those recited herein can result in thick coatings which can be too brittle to withstand subsequent processing of the impregnated paper (e.g., folding). Weight ratios of nonwoven fibrous mat to polyetherimide composition less than those recited herein can result in insufficient impregnation of the mat which can lead to reinforced papers not having the desired properties (e.g., mechanical strength and reduced water uptake).

The method can optionally further comprise contacting the reinforced paper with a second impregnating composition to provide a reinforced paper impregnated with an additional polymer composition, preferably wherein the additional polymer composition has a different composition from the impregnating composition described above. In some embodiments, the second impregnating composition comprises an organic solvent and a poly(phenylene ether). The poly(phenylene ether) can be as described above. Exemplary organic solvents can include toluene, chloroform, N-methyl-2-pyrrolidone, anisole, xylene, acetone, methyl ethyl ketone, cyclohexanone, methyl isobutyl ketone, methyl acetate, ethyl acetate, butyl acetate, isopropyl acetate, amyl acetate, N,N′-dimethyl formamide, N,N′-dimethylacetamide, dioxane, tetrahydrofuran, 2-ethoxyethyl acetate, or a combination thereof. Particular organic solvents can be selected depending on the specific poly(phenylene ether) selected for use in the impregnating composition. For example, suitable solvents for use with a poly(phenylene ether) comprising repeating units derived from 2,6-dimethylphenol can include toluene, chloroform, or a combination thereof. Suitable solvents for use with a poly(phenylene ether) copolymer comprising repeating units derived from 2,6-dimethylphenol and 2-methyl-6-phenyl phenol can include toluene, chloroform, N-methyl-2-pyrrolidone, or a combination thereof, preferably N-methyl-2-pyrrolidone. Suitable solvents for use with a poly(phenylene ether) oligomer can include toluene, anisole, xylene, acetone, methyl ethyl ketone, cyclohexanone, methyl isobutyl ketone, methyl acetate, ethyl acetate, butyl acetate, isopropyl acetate, amyl acetate, N,N′-dimethyl formamide, N,N′ -dimethyl acetamide, N-methyl pyrrolidone, dioxane, tetrahydrofuran, 2-ethoxyethyl acetate, or a combination thereof.

In some embodiments, when the second impregnating composition includes a bifunctional poly(phenylene ether) or phenylene ether oligomer, as described above, a multifunctional, for example a bifunctional, epoxy, can also be included in the second impregnating composition in order to cure the bifunctional poly(phenylene ether) or phenylene ether oligomer upon heating. Combinations of one or more epoxies, optionally having different numbers is epoxy groups per molecule can also be used. As discussed above, without wishing to be bound by theory, it is believed that the multifunctional epoxy can increase the molecular weight of the polymer through formation of a crosslinked network. Exemplary bifunctional epoxy materials are described above, and a particularly useful bifunctional epoxy crosslinker can be bisphenol A diglycidyl ether, available as D.E.R. 332 from Dow.

The process described above can optionally be repeated as necessary to provide the reinforced paper comprising the impregnating composition in a desired amount or having a desired composition (e.g., comprising polyetherimide and poly(phenylene ether)).

Another aspect of the present disclosure is an article comprising the above-described reinforced paper, or a reinforced paper prepared according to the above-described method. The reinforced papers can be useful in a variety of applications, in particular where low weight in combination with improved mechanical strength and low water absorption are advantageous, for example in transportation, furniture, packaging, pallets, and containers. In some embodiments, the reinforced paper can be used to form a structural panel, for example as the core material in a sandwich structure panel. A structural panel can include the core structure, and a skin layer disposed on one or both surfaces of the core structure. The reinforced paper useful as a core material for such panels can be a honeycomb or other folded cell paper, as described above. The skin layer can be a protective layer, and can generally be any planar material which can be bound to the core material, for example, a polycarbonate film, a glass fiber mat, a flame retardant fabric, sheet metal, a non-woven reinforced polymer sheet, or a combination thereof. Such panels can be useful for articles that can serve as interior and exterior surfaces such as floors, walls, ceilings, doors, lids, covers, seats, tables, and counters for aircraft, rail, marine, automotive, and construction applications.

Accordingly, the reinforced paper described herein can advantageously provide a lightweight structural material that has reduced water absorption and good mechanical strength. Furthermore, the method for the manufacture of the reinforced paper is environmentally friendly (e.g., organic solvents are not required for use with the polyamic acid salt). Therefore, a significant improvement in reinforced papers, methods of making the reinforced papers, and articles including the reinforced paper is provided by the present disclosure.

The invention is further illustrated by the following non-limiting examples.

### EXAMPLES

Materials used for the following Examples are described in Table 1.

TABLE 1

| Component | Description |
|---|---|
| PEI-1 | A polyetherimide comprising repeating units derived from bisphenol A dianhydride and meta- |
| | phenylene diamine, having a glass transition temperature of 217° C., and having a weight average |
| | molecular weight of 55,000 grams per mole, available as ULTEM 1000 from SABIC. |
| PEI-2 | A copolyetherimide comprising repeating units derived from bisphenol A dianhydride and para- |
| | phenylene diamine, having a glass transition temperature of 225° C., and a weight average |
| | molecular weight of 56,000 grams per mole, available as ULTEM CRS5001 from SABIC. |
| Pre-PEI-1 | A polyamic acid salt comprising repeating units derived from bisphenol A dianhydride and meta- |
| | phenylene diamine, prepared according to the procedure described in WO 2016/109354, and |
| | further described below. |
| Pre-PEI-2 | A polyamic acid salt comprising repeating units derived from bisphenol A dianhydride and para- |
| | phenylene diamine, prepared according to the procedure described in WO 2016/109354, and |
| | further described below. |
| PPE-1 | A phenylene ether oligomer comprising repeating units derived from 2,6-dimethylphenol and a |
| | single unit of tetramethylbisphenol A, having an intrinsic viscosity of 0.09 deciliter per gram, a |
| | glass transition temperature of 140° C., and a number average molecular weight of 1,600 |
| | grams/mole. Available as NORYL Resin SA90 from SABIC. |
| PPE-2 | A poly(phenylene ether) comprising repeating units derived from 2,6-dimethylphenol, having an |
| | intrinsic viscosity of 1.5 deciliter per gram, a glass transition temperature of 220° C., and a number |
| | average molecular weight of 350,000 grams per mole. Available as PPO6130 from SABIC. |
| PPE-3 | A poly(phenylene ether) copolymer comprising repeating units derived from 2,6-dimethylphenol |
| | and 2-methyl-6-phenyl phenol in a mole ratio of 80:20, having an intrinsic viscosity of 1.5 |
| | deciliter per gram. PPE-3 was prepared according to the procedure described below. |
| BPA epoxy | Bisphenol A diglycidyl ether, CAS Reg. No. 1675-54-3, having an epoxy equivalent weight of |
| | 171-175 g/eq. Available as D.E.R 332 from DOW Chemical Company. |
| Paper-1 | Paper comprising meta-aramid fibers, having a thickness of 80 micrometers (3 mils). Available |
| | as NOMEX Paper Type 410 from Dupont. |
| Paper-2 | An unconsolidated nonwoven paper comprising 50 weight percent polyetherimide (obtained as |
| | ULTEM 1000 from SABIC) fibers, 35 weight percent aramid (obtained as TWARON from |
| | Teijin Aramid), and 15 weight percent of a para-aramid pulp (obtained as TWARON pulp from |
| | Teijin Aramid). |
| Paper-3 | A consolidated nonwoven paper comprising 50 weight percent polyetherimide (obtained as |
| | ULTEM 1000 from SABIC) fibers, 35 weight percent aramid (obtained as TWARON from |
| | Teijin Aramid), and 15 weight percent of a para-aramid pulp (obtained as TWARON pulp from |
| | Teijin Aramid). Paper-3 was consolidated by a high temperature double-belt process. |
| Toluene | CAS Reg. No. 108-88-3; obtained from Fisher Scientific. |
| NMP | N-methyl-2-pyrrolidone, CAS Reg. No. 872-50-4, Fisher Scientific |
| MeOH | Methanol; obtained from Sigma-Aldrich |
| DMEA | Dimethylethanolamine; obtained from Sigma-Aldrich |
| TEA | Triethylamine; obtained from Sigma-Aldrich |

The polyamic acid salt (“pre-PEI-1”) in water and dimethylethanolamine (DMEA) was prepared according to the following procedure. Acetone (341.4 grams) and bisphenol-A dianhydride (BPA-DA; CAS. Reg. No. 38103-06-9) (120.0772 grams) were added to a 2 liter 3-neck round bottom flask equipped with an agitator, Dean Stark apparatus and nitrogen purging. Acetone (347.8 grams) and deionized water (235 grams) was then added to the flask. Para-phenylene diamine (PPD; CAS Reg. No. 106-53-3) (24.92 grams) was then added very slowly with continued agitation followed by acetone (380.1 grams). The contents were reacted at 30° C. for 20 minutes. N,N-dimethylethanolamine (DMEA) (60.5 grams) was added to the reactor and the contents were allowed to react overnight at 75° C. under refluxing conditions. Acetone (180 grams) from the reactor was removed by heating and additional deionized water (160 grams) was added. The final solution was a golden homogeneous solution.

A sample of the above prepolymer solution was dried at 120° C. and evaluated for residual monomers by high performance liquid chromatography (HPLC). Low levels (<10 ppm) of residual diamine were noted.

One gram of the prepolymer solution was heated to 385° C. under nitrogen for 15 minutes. The molecular weight of the resulting polymer was measured using GPC by dissolving the polymer in methylene chloride. The polymer exhibited a weight average molecular weight (Mw) of 77,605 grams per mole, a number average molecular weight (Mn) of 28,346 grams per mole and a polydispersity index of 2.74. The molecular weights are based on polystyrene standards.

The polyamic acid salt (“pre-PEI-2”) in methanol and triethylamine was prepared according to the following procedure. Bisphenol-A dianhydride (BPA-DA; CAS. Reg. No. 38103-06-9) powder (170 grams, 0.3266 moles) and methanol (250 grams) were taken in a three neck 2 liter glass reactor equipped with stirrer, nitrogen inlet and cold water circulated refluxing condenser. The contents were stirred under nitrogen atmosphere at 23° C. To the slurry, para-phenylene diamine (PPD; CAS Reg. No. 106-53-3) powder (35.3069 grams, 0.3266 moles) was added slowly. The contents were stirred for 3 hours under nitrogen atmosphere at 50° C. During the course of reaction, 0.3 grams of the slurry was taken out periodically and dried in a vacuum oven at 80° C. to remove the solvent. The dried samples were evaluated for residual monomers by HPLC method. After 3 hours of reaction, low levels of (<10 ppm) PPD residual monomer was noted indicating completion of reaction. Triethylamine (47.5 grams) was added to the reactor and continued agitation at 50° C. overnight, which resulted in a homogenous solution. It was confirmed that the final prepolymer homogeneous solution also contained <10 ppm residual diamine by HPLC. The final prepolymer solution had 41.5% solids and exhibited a viscosity of 58.5 centipoise at 23° C. One gram of the final prepolymer solution was heated to 385° C. under nitrogen for 15 minutes. The molecular weight of the resulting polymer was measured using GPC by dissolving the polymer in 50:50 (volume/volume) methylene chloride:hexafluoroisopropyl alcohol. The polymer exhibited a weight average molecular weight (Mw) of 89,702 grams per mole, a number average molecular weight (Mn) of 50,911 grams/mole and a polydispersity index of 1.762. The molecular weights are based on polystyrene standards. The polyimide polymer exhibited a glass transition temperature (Tg) of 231.2° C. and a TGA onset temperature of 546.8° C. in air and 550.2° C. in nitrogen.

Thermal Desorption Gas Chromatography-Mass Spectrometry (TD-GC-MS) was used to ascertain low levels of residual monomers in the prepolymer solution. One gram of pre-polymer solution was dried in a vacuum oven at 80° C. to remove most of the solvents. The resulting dried sample was analyzed by TD-GC-MS. The sample was heated to 350° C. for 15 minutes and desorbed compounds were cryogenically trapped (−120° C.). The trap was then rapidly heated to 350° C. and evolved compounds were analyzed by GC-MS.

GC-MS analysis was performed on an Agilent 5975 GC-MS instrument. A ZB-5MS column (30M×0.25 mm ID×0.25 micrometer film thickness) was used to separate the analytes of interest. The oven was initially held at 60° C. for 5 min and then ramped at 10° C./min to 250° C. and held for 6 min. A helium carrier gas was used at a constant flow of 1.0 ml/min The mass spectrometer was operated in scan mode (35-1000 amu). Diamine (molecular weight: 108.1 grams per mole) was not present in the evolved compounds.

The PPE-3 copolymer was prepared according to the following experimental procedure. The oxidative coupling polymerization reaction was carried out in a bubbling reactor, a Mettler Toledo RC1e reactor, Type 3, 1.8 liters, 100 bar, equipped with a stirrer, temperature control system, nitrogen padding, oxygen bubbling tube, and computerized control system (including two RD10 controllers). Toluene (875 grams), a 2,6-diemthyl phenol (DMP)/2-methyl-6-phenyl phenol (MPP)/toluene (37/14/41) solution (11.82 grams), N,N-dimethylbutylamine (DMBA) (10.38 grams), di-n-butylamine (DBA) (2.90 grams), and a mixture of N,N′-di-t-butylethylenediamine (DBEDA) (1.58 grams), phase transfer agent (obtained as MAQUAT from Mason Chemical Company) (0.84 grams), and toluene (2.85 grams) were charged to a 1.8 liter bubbling polymerization vessel and stirred under nitrogen. Catalyst solution (5.11 grams: 0.37 grams Cu₂O and 4.74 grams (48%) HBr) was added to the above reaction mixture. After the addition of catalyst solution, oxygen flow was started. The rest of the monomer solution, DMP/MPP/toluene (37/14/41) (146.12 grams), was added slowly at 2.44 g/min over 60 minutes. The temperature was ramped from 25° C. to 48° C. over 75 minutes. Oxygen flow was maintained for 156 minutes, at which point the flow was stopped. The reaction solution was transferred into another vessel where trisodium nitrilotriacetate (NTA) (13.46 grams) and water (28.69 grams) were added to the reaction mixture. The resulting mixture was stirred at 60° C. for 2 hours. The layers were separated by centrifugation and toluene phase was precipitated into methanol. The particles were filtered and washed with methanol followed by drying in a vacuum oven at 110° C. under nitrogen overnight.

Reinforced papers used for the following examples were prepared according to the following general procedure. Impregnating compositions were prepared by dissolving the desired polymer or prepolymer in a suitable solvent at a preselected concentration. The paper (i.e., paper-1, paper-2 or paper-3) was impregnated with the impregnating composition by dip-coating. The paper was immersed in the composition for 5 minutes at room temperature in air. The paper was then air-dried (with or without vacuum), and subsequently heat-treated at a temperature of 250 to 260° C. to provide the reinforced papers.

The molecular weights of the polymers were characterized using gel permeation chromatography (GPC). Polymers were dissolved in a 1:1 (volume) ratio of methylene chloride and hexafluoroisopropyl alcohol. Molecular weights were determined relative to polystyrene standards.

The tensile properties of the reinforced paper were characterized in terms of the ratio of maximum load to break to paper weight using a customized testing method based on ASTM D638-14, using specimen Type-IV tested at a rate of 5 millimeters per minute (mm/min).

Water absorption of the reinforced papers was analyzed by submerging the paper in water for eight days at room temperature. After removal, excess water was lightly wiped from the paper, and the paper was weighed. The weight of the submerged paper was compared to that of the paper prior to submersion in water to determine the water absorption of the reinforced paper.

Molecular weight increase of the prepolymers during heat treatment was first assessed in both air and nitrogen atmospheres. An impregnating composition having a solids content of 3 to 12.5 weight percent of Pre-PEI-2 was prepared in methanol, as described above. According to the general procedure described above, paper 2 was dip-coated in the impregnating composition for 5 minutes at room temperature, allowed to air dry for 2 hours, and subjected to heat treatment at 250° C.

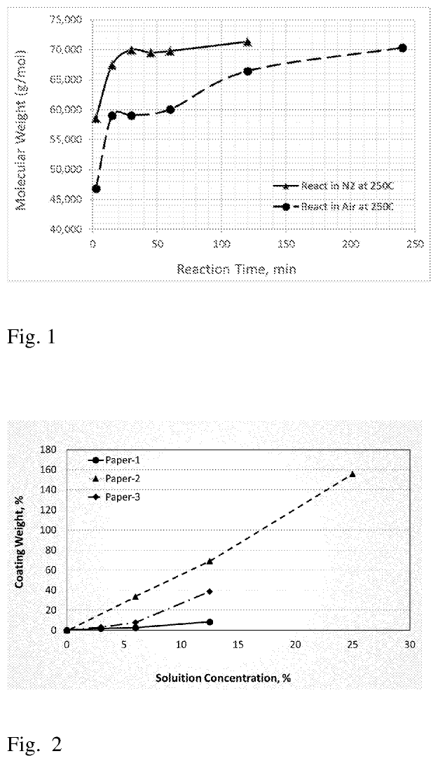

At pre-selected time points, the molecular weight of the polymer was assessed by dissolving in a 1:1 (by volume) solution of methylene chloride and hexafluoroisopropyl alcohol, and analyzing by GPC, as described above. The weight average molecular weight of the polymer over time when polymerized by heat treatment at 250° C. in nitrogen or air is shown in FIG. 1. As a reference, commercial PEI samples PEI-1 and PEI-2 have molecular weights of about 52,000 and 49,000 grams per mole, respectively. A control sample obtained by heating pre-PEI-2 at 385° C. for 15 minutes under nitrogen shows that high molecular weight (about 72,000 grams per mole) can be obtained quickly under these conditions. Heat treating pre-PEI-2 at 250° C. in nitrogen yielded a polymer molecular weight of about 70,000 grams per mole after 30 minutes, and heat treating at 250° C. in air yielded a polymer molecular weight of about 70,000 grams per mole after 220 minutes. The data shown in FIG. 1 is also provided in Table 2 below.

TABLE 2

| | | | Heating | | | |
|---|---|---|---|---|---|---|
| | | Temperature | Time | Mw | Mn | PDI |
| Example | Atmosphere | (° C.) | (minutes) | (grams/mole) | (grams/mole) | (Mw/Mn) |
| 1 | N₂ Control | 385 | 15 | 71,900 | 33,700 | 1.14 |
| | | | 2.5 | 58,500 | 21,500 | 2.72 |
| | | | 15 | 67,400 | 29,400 | 2.29 |
| 2 | N₂ | 250 | 30 | 70,000 | 27,700 | 2.53 |
| | | | 45 | 69,500 | 32,500 | 2.14 |
| | | | 60 | 69,800 | 28,000 | 2.49 |
| | | | 120 | 71,400 | 29,100 | 2.45 |
| | | | 2.5 | 46,800 | 15,200 | 3.07 |
| | | | 15 | 59,000 | 23,700 | 2.49 |
| 3 | Air | 250 | 30 | 59,000 | 26,500 | 2.23 |
| | | | 60 | 60,000 | 23,000 | 2.61 |
| | | | 120 | 66,500 | 26,000 | 2.56 |
| | | | 240 | 70,400 | 27,400 | 2.56 |

Pre-PEI-2 polymerizes vary rapidly to the level of commercial PEIs, as shown in FIG. 1 (within about 2.5 minutes in both air and nitrogen atmospheres at 250° C.). The polymerization was observed to be faster in nitrogen than in air, however high molecular weights could be obtained in air after longer times. The data indicates that pre-PEI-2 can be heat treated in air to provide a high molecular weight polymer impregnated within the paper. Without wishing to be bound by theory, the use of high molecular weight polymers for impregnating the paper is expected to advantageously provide improved mechanical strength of the reinforced paper.

Paper-1, -2, and -3 were impregnated using impregnating compositions having varying amounts of pre-PEI-2 (polymer concentrations were varied by diluting with methanol until the desired concentration was reached), and the weight of the reinforced paper was compared to that of the original paper to determine the amount of polymer impregnated therein. Table 3 below shows weight percentage (wt %) of impregnated polymer (based on the weight of the initial paper) for each of paper-1, paper-2, and paper-3 obtained from impregnating compositions having varying polymer concentrations. The data is also provided in FIG. 2.

TABLE 3

| | Pre-PEI-2 amount | | | |
|---|---|---|---|---|
| | in impregnating | Impregnated Amount (wt%) | | |
| Example | composition (wt%) | Paper-2 | Paper-1 | Paper-3 |
| 4 | 0 | 0 | | |
| 5 | 0 | | 0 | |
| 6 | 0 | | | 0 |
| 7 | 3 | not tested | | |
| 8 | 3 | | 1.8 | |
| 9 | 3 | | | 3.1 |
| 10 | 6 | 33.7 | | |
| 11 | 6 | | 2.6 | |
| 12 | 6 | | | 7.7 |
| 13 | 12.5 | 69.0 | | |
| 14 | 12.5 | | 8.4 | |
| 15 | 12.5 | | | 38.6 |
| 16 | 25 | 155.7 | | |
| 17 | 25 | | not tested | |
| 18 | 25 | | | not tested |

As shown in Table 3, paper-2, an unconsolidated paper, retained the highest amount of polymer from the composition, with the weight of the polymer retained increasing as the polymer concentration in the impregnating composition increased. Without wishing to be bound by theory, it is believe that unconsolidated paper-2 has increased porosity relative to the other papers tested, so more polymer could be absorbed from the solution (e.g., by enhanced impregnation of the polymer into the paper structure). Consolidated paper-3 was observed to retain higher amounts of the impregnated polymer compared to paper-1, for example 7.7% for paper-3 compared to 2.6% for paper-1 at 6% polymer concentration, and 38.6% for paper-3 compared to 8.4% for paper-1 at 12.5% polymer concentration.

To further examine the effect of polymer composition on weight increase of the paper after impregnating, various impregnating compositions were prepared using a polymer concentration of 3 weight percent, based on the total weight of the impregnating composition, as described in Table 4 below. After dip coating, the paper samples were dried and heat treated as described above. Table 4 also shows the amount of impregnated polymer that was added to the paper after one dip in the composition, reported as impregnated amount in weight percent, based on the weight of the initial paper.

TABLE 4

| | | | | | Impregnated |
|---|---|---|---|---|---|
| | | | Organic | | Amount (weight |
| Example | Polymer | Solvent | Amine | Paper | percent) |
| 19 | Pre-PEI-2 | MeOH | TEA | Paper-1 | 1.8 |
| 20 | Pre-PEI-1 | Water | DMEA | Paper-3 | 3.5 |
| 21 | Pre-PEI-2 | MeOH | TEA | Paper-3 | 4.5 |
| 22 | PEI-2 | NMP | — | Paper-3 | 2.6 |
| 23 | PEI-1 | NMP | — | Paper-3 | 3.2 |
| 24 | PPE-3 | NMP | — | Paper-3 | 3.3 |
| 25 | PPE-2 | Toluene | — | Paper-3 | 12.0 |

As shown in Table 4, after a single dip in an impregnating composition having 3 weight percent of a polymer component, the paper weight for samples 19-24 increased by about 2 to 4.5 weight percent. In other words, the polymer is present in an amount of about 2 to 4.5 weight percent, based on the initial weight of the paper. For sample 25, the weight was noted to increase by about 12%, which is believed to be due to the relatively higher viscosity of this impregnating composition.

The ability of the polymer impregnated in the papers to impart mechanical strength reinforcement was also evaluated by determining the normalized load to weight ratio for each sample, according to the procedure described above. Table 5, below, shows the normalized load to weight ratio for paper-1, paper-2, and paper-3 after impregnating with compositions having varying concentrations of the polymer component. Pre-PEI-2 dissolved in methanol with triethylamine was used as the impregnating composition. The papers were dip-coated one time, air dried, then heat treated as described above to provide the impregnated papers for testing.

TABLE 5

| | Impregnating | | | |
|---|---|---|---|---|
| | Composition | Normalized | | |
| | Polymer Amount | Load to Weight Ratio (N/g) | | |
| Example | (wt%) | Paper-1 | Paper-2 | Paper-3 |
| 26 | 0 | 349 | | |
| 27 | 0 | | 29 | |
| 28 | 0 | | | 158 |
| 29 | 3 | 372 | | |
| 30 | 3 | | not tested | |
| 31 | 3 | | | 267 |
| 32 | 6 | 376 | | |
| 33 | 6 | | 235 | |
| 34 | 6 | | | 276 |
| 35 | 13 | 348 | | |
| 36 | 13 | | 237 | |
| 37 | 13 | | | 144 |
| 38 | 25 | not tested | | |
| 39 | 25 | | 165 | |
| 40 | 25 | | | not tested |

It can be seen from the data shown in Table 5 that the load to weight ratio can be maximized when dip-coating with the above-described impregnating composition having a polymer concentration of 3 to 6 weight percent.

To further examine the effect of polymer composition on mechanical strength reinforcement of the paper, various compositions were prepared using a polymer concentration of 3 weight percent, based on the total weight of the composition, and using paper-3. After dip coating, the paper samples were dried, heat treated, and tested as described above. The results are summarized in Table 6 below.

TABLE 6

| | | Normalized | |
|---|---|---|---|
| Example | Polymer | Load to Weight Ratio (N/g) | Standard Deviation |
| 41 | — | 191.7 | 76.5 |
| 42 | Pre-PEI-2 | 279.6 | 29.9 |
| 43 | PEI-2 | 275.1 | 31.4 |
| 44 | PPE-3 | 317.1 | 37.8 |
| 45 | PPE-2 | 289.1 | 32.6 |
| 46 | PEI-1 | 322.0 | 20.3 |

As shown in Table 6, after a single dip in an impregnating composition having 3 weight percent of a polymer component, the mechanical strength could be improved relative to the paper sample of example 21.

Additional studies further showed that conducting the heat treatment in air or under vacuum yielded no statistically significant difference in the mechanical strength reinforcement of the reinforced papers. Specifically, the mean load to weight ratio for reinforced papers prepared via heat treatment in air was 272.53±61.35, and the mean load to weight ratio for reinforced papers prepared via heat treatment under vacuum was 247.0±78.5. Furthermore, no statistically significant difference in the load to weight ratio for a reinforced paper prepared from a 3 weight percent solution of either pre-PEI-1 in water or pre-PEI-2 in an alcohol was observed. Specifically, the mean load to weight ratio for reinforced papers prepared from a water solution was 269.8±29.8, and the mean load to weight ratio for reinforced papers prepared from a methanol solution was 289.5±28.2. Accordingly, the process described herein can advantageously provide a cost reduction in manufacturing reinforced papers, as well as options to meet strict environmental standards.

Reinforced papers can be particularly useful for structural applications, however a technical limitation of current papers used in structural panels is water absorption over time. Water absorption causes undesirable increases in weight, and eventually necessitates replacement of the panels. Water absorption of the reinforced papers of the present application was tested by submerging the reinforced paper sample in water for 8 days at 25° C. The water absorption was calculated by comparing the weight of the paper after being submerged in water to the weight of the paper prior to submersion in water.

Water absorption was compared for paper-1 and paper-3, as well as impregnated with an impregnating composition comprising pre-PEI-2 in methanol with triethylamine The results are summarized in Table 7, below.

TABLE 7

| | Impregnating Composition | Paper-1 Water | Paper-3 Water |
|---|---|---|---|
| Example | Polymer Amount (wt%) | Absorption (%) | Absorption (%) |
| 47 | 0 | 27.5 | |
| 48 | 0 | | 20.7 |
| 49 | 3 | 17.9 | |
| 50 | 3 | | 10.3 |
| 51 | 6 | 16.6 | |
| 52 | 6 | | 8.3 |
| 53 | 12.5 | 18.3 | |
| 54 | 12.5 | | 7.2 |

From the data in Table 7, it can be seen that paper-3 absorbs less water than paper-1. Additionally, once impregnated, paper-3 has a greater reduction in water absorption compared to paper-1. The above data taken together with the previously discussed mechanical strength reinforcement date suggests that the benefits of strength increase and reduced water absorption can be maximized when the papers are impregnated by dip coating in a composition including 3 weight percent of the polymer component. The water absorption for other polymers when impregnated at a concentration of 3 weight percent was also tested, and the data is provided in Table 8.

TABLE 8

| Example | Paper | Polymer | Water Absorption (%) |
|---|---|---|---|
| 49 | Paper-1 | Pre-PEI-2 | 17.9 |
| 50 | Paper-3 | Pre-PEI-2 | 10.3 |
| 55 | Paper-3 | Pre-PEI-1 | 11.1 |
| 56 | Paper-3 | PPE-1/BPA epoxy | 9.7 |
| 57* | Paper-3 | PPE-1/BPA epoxy | 10.3 |
| 58 | Paper-3 | PPE-2 | 8.4 |
| 59* | Paper-3 | PPE-2 | 7.6 |

*Example 57 and 59 papers were heat treated by a static press at 250° C. for 2 hours following dip-coating; all other examples were heat treated in a vacuum oven at 250° C. for 2 hours.

Reinforced papers prepared from pre-PEI-2 were prepared by dip-coating the paper in a composition comprising 3 weight percent pre-PEI-2 in methanol with triethylamine. Reinforced papers prepared from pre-PEI-1 were prepared by dip-coating the paper in a composition comprising 3 weight percent pre-PEI-1 diluted with deionized water and containing residual acetone. Reinforced papers prepared from PPE-1 were prepared by dip-coating the paper in a composition comprising 3 weight percent of a poly(phenylene ether) composition comprising 34.3 weight percent PPE-1, 63.7 weight percent BPA epoxy, and 2 weight percent 2-ethyl-4-methylimidazole in toluene. Reinforced papers prepared from PPE-2 were prepared by dip-coating the paper in a composition comprising 3 weight percent PPE-2 in toluene. The data in Table 8 shows that the water absorption can be significantly reduced even after a single contact with the various compositions.

Thus, dip-coating with the various polymer or pre-polymer compositions described herein can provide an effective way to reinforce paper, which can be particularly useful for structural applications, for example in aerospace applications. Reinforcing the papers can also reduce or eliminate premature mechanical failure of the paper due to paper defects.

The reinforced paper, methods, and articles disclosed herein include at least the following embodiments.

Embodiment 1: A reinforced paper comprising a nonwoven fibrous mat comprising a reinforcing fiber, a high strength toughening fiber, or a combination thereof; wherein the nonwoven fibrous mat is impregnated with a polyetherimide composition; and wherein the polyetherimide composition comprises a polyetherimide comprising repeating units of the formula

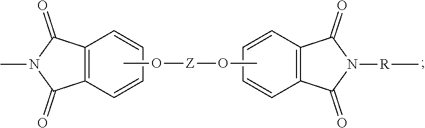

wherein each occurrence of R is independently a substituted or unsubstituted C₆₋₂₀ aromatic hydrocarbon group, a substituted or unsubstituted straight or branched chain C₄₋₂₀ alkylene group, a substituted or unsubstituted C₃₋₈ cycloalkylene group, or a combination thereof; and each occurrence of Z is independently a group of the formula

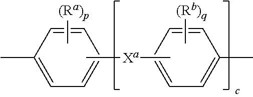

wherein R^{a} and R^{b} are each independently a halogen atom or a monovalent C₁₋₆ alkyl group; p and q are each independently integers of 0 to 4; c is 0 to 4; and X^{a} is a single bond, —O—, —S—, S(O)—, —SO₂—, —C(O)—, or a C₁₋₁₈ organic bridging group.

Embodiment 2: The reinforced paper of embodiment 1, wherein the reinforcing fiber comprises carbon fiber, carbon nanotubes, glass fiber, basalt fiber, silicon carbide fiber, tungsten carbide fiber, wollastonite fibers, alumina fibers, silica fibers, or a combination thereof; and the high strength toughening fiber comprises aromatic polyamide, polybenzimidazole, liquid crystal polymer, or a combination thereof.

Embodiment 3: The reinforced paper of embodiment 1 or 2, wherein the fibrous mat further comprises a thermoplastic fiber comprising a polyetherimide, a polyetherimide sulfone, a polyphenylene sulfide, a polyether ether ketone, a polyphenylene benzobisoxazole, a polytetrafluoroethylene, or a combination thereof; and a binder comprising polycarbonate, polyalkylene terephthalate, polyamide, polypropylene, or a combination thereof.

Embodiment 4: The reinforced paper of any one of embodiments 1 to 3, wherein the nonwoven fibrous mat is a consolidated fibrous mat comprising: 3 to 30 weight percent of a reinforcing fiber comprising carbon fiber; 5 to 55 weight percent of a high strength toughening fiber comprising an aromatic polyamide; 20 to 80 weight percent of a polyetherimide fiber; and 0 to 20 weight percent of a binder comprising polycarbonate fiber; wherein weight percent of each component is based on the total weight of the nonwoven fibrous mat.

Embodiment 5: The reinforced paper of any one of embodiments 1 to 4, wherein the reinforced paper has a folded cell structure comprising a plurality of interconnected walls comprising the nonwoven fibrous mat that define a plurality of folded cells.

Embodiment 6: The reinforced paper of any one of embodiments 1 to 5, wherein Z is 4,4′-diphenylene isopropylidene, and R is para-phenylene, meta-phenylene, or a combination thereof.

Embodiment 7: The reinforced paper of any one of embodiments 1 to 6, wherein the polyetherimide composition further comprises greater than 0 to 20 weight percent of a plasticizer, wherein the plasticizer is effective to reduce the glass transition temperature of the polyetherimide composition relative to the glass transition temperature of the polyetherimide composition not having the plasticizer.

Embodiment 8: The reinforced paper of any one of embodiments 1 to 7, wherein the polyetherimide composition further comprises a poly(phenylene ether) comprising repeating units of the formula

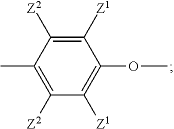

wherein each occurrence of Z¹ is independently halogen, unsubstituted or substituted C₁-C₁₂ hydrocarbyl provided that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms; and each occurrence of Z² is independently hydrogen, halogen, unsubstituted or substituted C₁-C₁₂ hydrocarbyl provided that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms.

Embodiment 9: The reinforced paper of embodiment 8, wherein the poly(phenylene ether) is a copolymer comprising 2,6-dimethyl-1,4-phenylene ether repeating units and 2-methyl-6-phenyl-1,4-phenylene ether repeating units.

Embodiment 10: The reinforced paper of any one of embodiments 1 to 9, comprising the nonwoven fibrous mat and the polyetherimide composition in a weight ratio of 1:0.01 to 1:5.

Embodiment 11: The reinforced paper of any one of embodiments 1 to 8, wherein the polyetherimide has a weight average molecular weight of greater than 10,000 grams per mole.

Embodiment 12: The reinforced paper of any one of embodiments 1 to 11, wherein the reinforced paper has a folded cell structure comprising a plurality of interconnected walls comprising the nonwoven fibrous mat that define a plurality of folded cells, wherein the nonwoven fibrous mat is a consolidated fibrous mat comprising, based on the total weight of the fibrous mat, 3 to 30 weight percent of a reinforcing fiber comprising carbon fiber; 5 to 55 weight percent of a high strength toughening fiber comprising an aromatic polyamide; 20 to 80 weight percent of a polyetherimide fiber; and 0 to 20 weight percent of a binder comprising polycarbonate fibers, polyamide fibers, polyester fibers, or a combination thereof; and the polyetherimide comprises repeating units of the formula

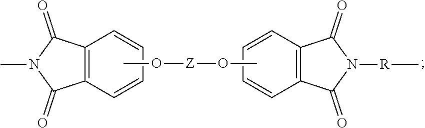

wherein Z is 4,4′-diphenylene isopropylidene, and R is para-phenylene, meta-phenylene, or a combination thereof.

Embodiment 13: A method of making a reinforced paper, the method comprising contacting at least a portion of a nonwoven fibrous mat comprising a reinforcing fiber, a high strength toughening fiber, or combination thereof, with a composition comprising a solvent and a polyetherimide, a polyamic acid salt, or a combination thereof to form a pre-preg; and heating the pre-preg under conditions effective to provide the reinforced paper comprising the nonwoven fibrous mat impregnated with a polyetherimide composition.

Embodiment 14: The method of embodiment 13, wherein the composition comprises an organic solvent and a polyetherimide.

Embodiment 15: The method of embodiment 13, wherein the composition comprises water, a C₁₋₆ alcohol, or a combination thereof, and a polyamic acid salt.

Embodiment 16: The method of any one of embodiments 13 to 15, wherein the composition comprises 1 to less than 60 weight percent, based on the total weight of the composition, of the polyetherimide, the polyamic acid salt, or combination thereof.

Embodiment 17: The method of any one of embodiments 13 to 16, wherein heating the pre-preg is at a temperature of 175 to 400° C.

Embodiment 18: The method of any one of embodiments 13 to 17, wherein the reinforced paper has a folded cell structure comprising a plurality of interconnected walls comprising the nonwoven fibrous mat that define a plurality of folded cells; the nonwoven fibrous mat is a consolidated fibrous mat comprising, based on the total weight of the fibrous mat, 3 to 30 weight percent of a reinforcing fiber comprising carbon fiber; 5 to 55 weight percent of a high strength toughening fiber comprising an aromatic polyamide; 20 to 80 weight percent of a polyetherimide fiber; and 0 to 30 weight percent of a binder comprising polycarbonate fiber; the composition comprises water, a C₁₋₆ alcohol, or a combination thereof, and a polyamic acid salt in an amount of 1 to 60 weight percent, based on the total weight of the impregnating composition; and heating the pre-preg is at a temperature of 150 to 400° C.

Embodiment 19: The method of any one of embodiments 13 to 18, wherein the method further comprises contacting the reinforced paper with a second composition to provide a reinforced paper impregnated with a second polymer composition.

Embodiment 20: The method of embodiment 19, wherein the second composition comprises a second solvent and a poly(phenylene ether), preferably wherein the poly(phenylene ether) is a poly(phenylene ether) copolymer comprising 2,6-dimethyl-1,4-phenylene ether repeating units and 2-methyl-6-phenyl-1,4-phenylene ether repeating units and the second solvent.

Embodiment 21: An article comprising the reinforced paper of any one of embodiments 1 to 12.

Embodiment 22: The article of embodiment 21, wherein the article is a structural panel comprising a core structure comprising the reinforced paper and a skin layer disposed on one or both surfaces of the core structure.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

All ranges disclosed herein are inclusive of the endpoints, and the endpoints are independently combinable with each other. Each range disclosed herein constitutes a disclosure of any point or sub-range lying within the disclosed range.

1. A reinforced paper comprising:
a nonwoven fibrous mat comprising a reinforcing fiber, a high strength toughening fiber, or a combination thereof;
wherein the nonwoven fibrous mat is impregnated with a polyetherimide composition; and
wherein the polyetherimide composition comprises a polyetherimide comprising repeating units of the formula 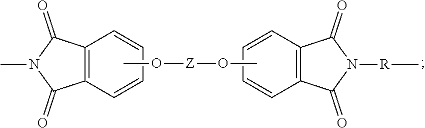
wherein
each occurrence of R is independently a substituted or unsubstituted C₆₋₂₀ aromatic hydrocarbon group, a substituted or unsubstituted straight or branched chain C₄₋₂₀ alkylene group, a substituted or unsubstituted C₃₋₈ cycloalkylene group, or a combination thereof; and
each occurrence of Z is independently a group of the formula 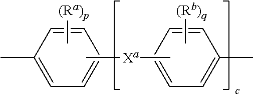
wherein
R^{a} and R^{b} are each independently a halogen atom or a monovalent C₁₋₆ alkyl group;
p and q are each independently integers of 0 to 4;
c is 0 to 4; and
X^{a} is a single bond, —O—, —S—, —S(O)—, —SO₂—, —C(O)—, or a C₁₋₁₈ organic bridging group.

2. The reinforced paper of claim 1, wherein
the reinforcing fiber comprises carbon fiber, carbon nanotubes, glass fiber, basalt fiber, silicon carbide fiber, tungsten carbide fiber, wollastonite fibers, alumina fibers, aluminium silicate fibers, silica fibers, or a combination thereof; and
the high strength toughening fiber comprises aromatic polyamide, polybenzimidazole, liquid crystal polymer, or a combination thereof.

3. The reinforced paper of claim 1, wherein the fibrous mat further comprises
a thermoplastic fiber comprising a polyetherimide, a polyetherimide sulfone, a polyphenylene sulfide, a polyether ether ketone, a polyphenylene benzobisoxazole, a polytetrafluoroethylene, or a combination thereof; and
a binder comprising polycarbonate, polyalkylene terephthalate, polyamide, polypropylene, or a combination thereof.

4. The reinforced paper of claim 1, wherein the nonwoven fibrous mat is a consolidated fibrous mat comprising:
3 to 30 weight percent of a reinforcing fiber comprising carbon fiber;
5 to 55 weight percent of a high strength toughening fiber comprising an aromatic polyamide;
20 to 80 weight percent of a polyetherimide fiber; and
0 to 20 weight percent of a binder comprising polycarbonate fiber;
wherein weight percent of each component is based on the total weight of the nonwoven fibrous mat.

5. The reinforced paper of claim 1, wherein the reinforced paper has a folded cell structure comprising a plurality of interconnected walls comprising the nonwoven fibrous mat that define a plurality of folded cells.

6. The reinforced paper of claim 1, wherein
Z is 4,4′-diphenylene isopropylidene, and
R is para-phenylene, meta-phenylene, or a combination thereof.

7. The reinforced paper of claim 1, wherein the polyetherimide composition further comprises greater than 0 to 20 weight percent of a plasticizer.

8. The reinforced paper of claim 1, wherein the polyetherimide composition further comprises a poly(phenylene ether) comprising repeating units of the formula 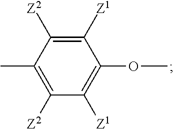
wherein each occurrence of Z¹ is independently halogen, unsubstituted or substituted C₁-C₁₂ hydrocarbyl provided that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms; and each occurrence of Z² is independently hydrogen, halogen, unsubstituted or substituted C₁-C₁₂ hydrocarbyl provided that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms.

9. The reinforced paper of claim 8, wherein the poly(phenylene ether) is a copolymer comprising 2,6-dimethyl-1,4-phenylene ether repeating units and 2-methyl-6-phenyl-1,4-phenylene ether repeating units.

10. The reinforced paper of claim 1, comprising the nonwoven fibrous mat and the polyetherimide composition in a weight ratio of 1:0.01 to 1:5.

11. The reinforced paper of claim 1, wherein the polyetherimide has a weight average molecular weight of greater than 10,000 grams per mole.

12. The reinforced paper of claim 1, wherein
the reinforced paper has a folded cell structure comprising a plurality of interconnected walls comprising the nonwoven fibrous mat that define a plurality of folded cells, wherein the nonwoven fibrous mat is a consolidated fibrous mat comprising, based on the total weight of the fibrous mat,
3 to 30 weight percent of a reinforcing fiber comprising carbon fiber;
5 to 55 weight percent of a high strength toughening fiber comprising an aromatic polyamide;
20 to 80 weight percent of a polyetherimide fiber; and
0 to 20 weight percent of a binder comprising polycarbonate fibers, polyamide fibers, polyester fibers, or a combination thereof; and
the polyetherimide comprises repeating units of the formula 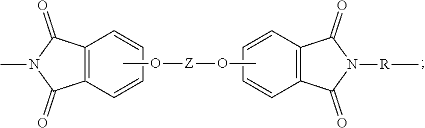
wherein Z is 4,4′-diphenylene isopropylidene, and
R is para-phenylene, meta-phenylene, or a combination thereof.

13. A method of making a reinforced paper, the method comprising
contacting at least a portion of a nonwoven fibrous mat comprising a reinforcing fiber, a high strength toughening fiber, or combination thereof, with a composition comprising a solvent and a polyetherimide, a polyamic acid salt, or a combination thereof to form a pre-preg; and
heating the pre-preg under conditions effective to provide the reinforced paper comprising the nonwoven fibrous mat impregnated with a polyetherimide composition.

14. The method of claim 13, wherein the composition comprises
an organic solvent and a polyetherimide, or
water, a C₁₋₆ alcohol, or a combination thereof and a polyamic acid salt.

15. The method of claim 13, wherein the composition comprises 1 to less than 60 weight percent, based on the total weight of the composition, of the polyetherimide, the polyamic acid salt, or combination thereof.

16. The method of claim 13, wherein heating the pre-preg is at a temperature of 150 to 400° C.

17. The method of claim 13, wherein
the reinforced paper has a folded cell structure comprising a plurality of interconnected walls comprising the nonwoven fibrous mat that define a plurality of folded cells;
the nonwoven fibrous mat is a consolidated fibrous mat comprising, based on the total weight of the fibrous mat,
3 to 30 weight percent of a reinforcing fiber comprising carbon fiber;
5 to 55 weight percent of a high strength toughening fiber comprising an aromatic polyamide;
20 to 80 weight percent of a polyetherimide fiber; and
0 to 30 weight percent of a binder comprising polycarbonate fiber;
the composition comprises water, a C₁₋₆ alcohol, or a combination thereof, and a polyamic acid salt in an amount of 1 to 60 weight percent, based on the total weight of the composition; and
heating the pre-preg is at a temperature of 150 to 400° C.

18. The method of claim 13, wherein the method further comprises contacting the reinforced paper with a second composition to provide a reinforced paper impregnated with a second polymer composition.

19. The method of claim 18, wherein the second composition comprises a second solvent and a poly(phenylene ether).

20. An article comprising the reinforced paper of claim 1, wherein the article is a structural panel comprising a core structure comprising the reinforced paper and a skin layer disposed on one or both surfaces of the core structure.
